(19) United States
(12) Patent Application Publication
(10) Pub. No.: US 2019/0029067 A1
(43) Pub. Date: Jan. 24, 2019

(54) COMMUNICATION CONTROL SYSTEM, COMMUNICATION CONTROL APPARATUS, AND METHOD OF IMPLEMENTATION OF CONTROLLING OF COMMUNICATION PROCESSING

(71) Applicant: Takayasu OE, Kanagawa (JP)

(72) Inventor: Takayasu OE, Kanagawa (JP)

(21) Appl. No.: 16/035,769

(22) Filed: Jul. 16, 2018

(30) Foreign Application Priority Data
Jul. 19, 2017 (JP) 2017-139679

(51) Int. Cl. H04W 76/20; H04W 36/00; H04W 76/15; H04W 56/00; H04W 76/38; H04W 88/12

(52) U.S. Cl. CPC H04W 76/20; H04W 36/0069; H04W 88/12; H04W 56/003; H04W 76/38; H04W 76/15

(57) ABSTRACT

A communication control apparatus disposed in a specific area includes circuitry configured to transmit, using a second communication scheme, connection information used for performing communication between the communication control apparatus and a communication terminal using a first communication scheme, to the communication terminal when the communication terminal exists in the specific area, establish the communication with the communication terminal using the first communication scheme based on the connection information, compare a first condition including at least one of activation time information indicating activation of the controlling of communication processing and deactivation time information indicating deactivation of the controlling of communication processing, and a current time being measured in response to starting the controlling of communication, and deactivate the controlling of communication processing when the current time being measured deviates from the activation time information, or when the current time being measured corresponds to the deactivation time information.

### CROSS-REFERENCE TO RELATED APPLICATION

This application claims priority pursuant to 35 U.S.C. § 119(a) to Japanese Patent Application No. 2017-139679, filed on Jul. 19, 2017, in the Japan Patent Office, the disclosure of which is incorporated by reference herein in its entirety.

### BACKGROUND

### Technical Field

This disclosure relates to a communication control system, a communication control apparatus, and a method of implementation of controlling of communication processing.

### BACKGROUND ART

Access points used for wireless communication are disposed in various areas such as class rooms and conference rooms in schools, offices or the like, in which communication terminals can perform communication with the access points by locating the communication terminals closer to the access points. For example, one conventional art describes a communication system, in which a mobile terminal is connected to an information processing apparatus serving as an access point using short-range wireless communication such as the near field communication (NFC).

In this communication system, the information processing apparatus serving as the access point transmits connection information, such as a service set identifier (SSID) and a password, required to perform wireless communication to the mobile terminal using the short-range wireless communication. Then, the mobile terminal establishes wireless communication with the information processing apparatus using the acquired connection information. In this communication system, the mobile terminal can establish the wireless communication with the information processing apparatus by simply locating the mobile terminal closer to the information processing apparatus.

### SUMMARY

As one aspect of the present invention, a communication control apparatus is devised. The communication control apparatus disposed in a specific area includes circuitry configured to implement controlling of communication processing for communication between the communication control apparatus and a communication terminal, transmit, using a second communication scheme, connection information used for performing communication between the communication control apparatus and the communication terminal using a first communication scheme, to the communication terminal when the communication terminal exists in the specific area, the second communication scheme different from the first communication scheme, establish the communication between the communication control apparatus and the communication terminal using the first communication scheme based on the connection information transmitted to the communication terminal, compare a first condition including at least one of activation time information indicating activation of the controlling of communication processing and deactivation time information indicating deactivation of the controlling of communication processing, and a current time being measured in response to starting the controlling of communication, and deactivate the controlling of communication processing when the current time being measured deviates from the activation time information indicating activation of the controlling of communication processing, or when the current time being measured corresponds to the deactivation time information indicating deactivation of the controlling of communication processing.

As another aspect of the present invention, a communication control system including a communication control apparatus disposed in a specific area and a communication terminal is devised. The communication control system includes circuitry configured to implement controlling of communication processing for communication between the communication control apparatus and a communication terminal, transmit, using a second communication scheme, connection information used for performing the communication between the communication control apparatus and the communication terminal using a first communication scheme, from the communication control apparatus to the communication terminal when the communication terminal exists in the specific area, the second communication scheme different from the first communication scheme, establish the communication with the communication terminal using the first communication scheme based on the connection information transmitted to the communication terminal, compare a first condition including at least one of activation time information indicating activation of the controlling of communication processing and deactivation time information indicating deactivation of the controlling of communication processing, and a current time being measured in response to starting the controlling of communication processing, and deactivate the controlling of communication processing when the current time being measured deviates from the activation time information indicating activation of the controlling of communication processing, or when the current time being measured corresponds to the deactivation time information indicating deactivation of the controlling of communication processing.

As another aspect of the present invention, a method of implementation of controlling of communication processing of a communication control apparatus disposed in a specific area is devised. The method includes transmitting, from the communication control apparatus to a communication terminal using a second communication scheme when the communication terminal exists in the specific area, connection information to be used for performing communication between the communication control apparatus and the communication terminal using a first communication scheme, the second communication scheme different from the first communication scheme, establishing the communication between the communication control apparatus and the communication terminal using the first communication scheme based on the connection information transmitted to the communication terminal, measuring a current time in response to starting the controlling of communication processing, comparing a first condition including at least one of activation time information indicating activation of the controlling of communication processing and deactivation time information indicating deactivation of the controlling of communication processing, and the current time being measured, and deactivating the controlling of communication processing when the current time being measured deviates from the activation time information indicating activation of the controlling of communication processing, or when the current time being measured corresponds to the deactivation time information indicating deactivation of the controlling of communication processing.

### BRIEF DESCRIPTION OF THE DRAWINGS

A more complete appreciation of the description and many of the attendant advantages and features thereof can be readily obtained and understood from the following detailed description with reference to the accompanying drawings, wherein:

FIG. 1 illustrates an example of a schematic configuration of a communication control system of an embodiment;

FIGS. 2A, 2B, and 2C schematically illustrate an example of a usage of the communication control system of the embodiment;

FIG. 3 illustrates an example of a hardware block diagram of a communication control apparatus of the embodiment;

FIG. 4 illustrates an example of a hardware block diagram of a communication terminal of the embodiment;

FIG. 5 illustrates an example of functional block diagram of a communication control system including a communication control apparatus, a communication terminal, and a management apparatus of a first embodiment;

FIG. 6 illustrates an example of effective time information;

FIG. 7 illustrates an example of connection information;

FIG. 8 illustrates an example of connection time information;

FIG. 9 is an example of a sequence diagram illustrating connection processing of the communication control apparatus and the communication terminal in the communication control system of the first embodiment;

FIG. 10 illustrates an example of a sequence diagram illustrating disconnection processing of communication using a first communication method and deactivation processing of communication control function in the communication control system of the first embodiment;

FIG. 11 illustrates an example of a flowchart illustrating the steps of the disconnection processing of communication using the first communication method and the deactivation processing of communication control function in the communication control system of the first embodiment;

FIG. 12 illustrates an example of effective time information of a variant example of the first embodiment;

FIG. 13 illustrates an example of a functional block diagram of a communication control system including a communication control apparatus, a communication terminal, and a management apparatus of a second embodiment;

FIG. 14 illustrates an example of a sequence diagram illustrating connection processing of the communication control apparatus and the communication terminal in the communication control system of the second embodiment;

FIG. 15 illustrates an example of a sequence diagram illustrating disconnection processing of communication using the first communication method and deactivation processing of control communication control function of a communication control apparatus in the communication control system of the second embodiment

FIG. 16 illustrates an example of a flowchart illustrating the steps of processing of deactivating a communication control function in the communication control apparatus of the second embodiment; and

FIG. 17 illustrates an example of a sequence diagram illustrating disconnection processing of communication using the first communication method and deactivation processing of communication control function of a communication control apparatus in a communication control system of a third embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

A description is now given of exemplary embodiments of the present invention. It should be noted that although such terms as first, second, etc. may be used herein to describe various elements, components, regions, layers and/or units, it should be understood that such elements, components, regions, layers and/or units are not limited thereby because such terms are relative, that is, used only to distinguish one element, component, region, layer or unit from another region, layer or unit. Thus, for example, a first element, component, region, layer or unit discussed below could be termed a second element, component, region, layer or unit without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Hereinafter, a description is given of one or more embodiments of the present invention with reference to the drawings.

### System Configuration:

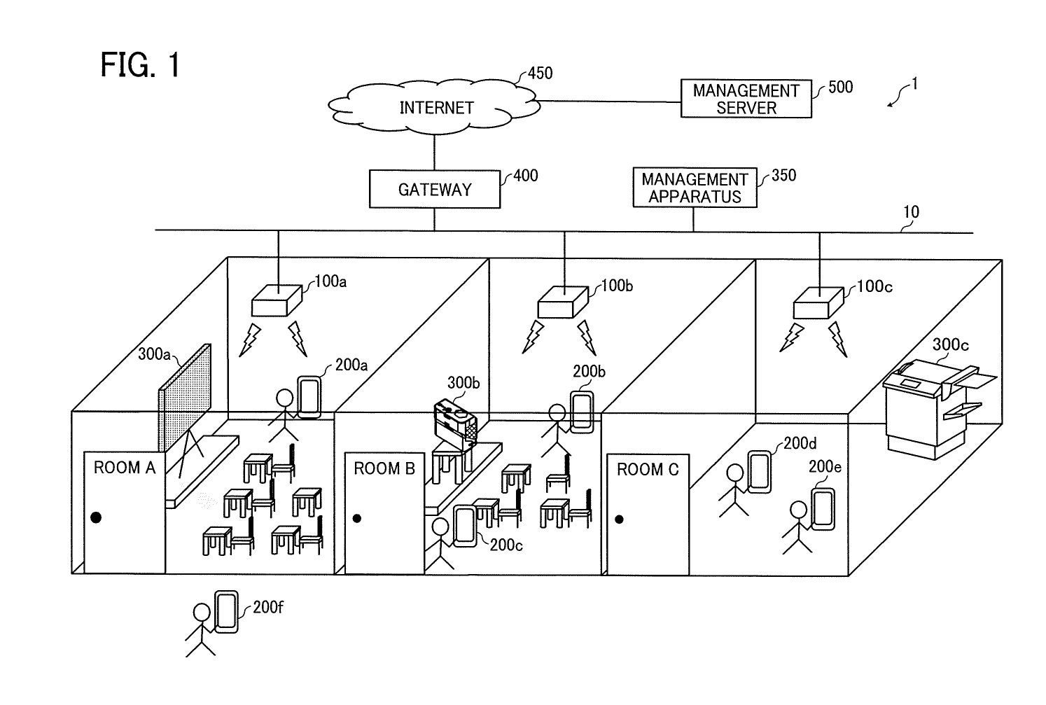

FIG. 1 illustrates an example of a schematic configuration of a communication control system 1 of an embodiment. As illustrated in FIG. 1, the communication control system 1 includes, for example, one or more communication terminals 200, a plurality of communication control apparatuses 100 each disposed in each of adjacent areas such as adjacent rooms. The communication control system 1 is configured to prevent occurrence of the unintended wireless communication between the communication terminal 200 and the communication control apparatus 100 disposed in each of the adjacent areas. FIG. 1 illustrates an example case of the communication control system 1, which is applied to rooms in one school.

As illustrated in FIG. 1, the communication control system 1 includes, for example, the communication control apparatus 100 (100a, 100b, 100c), the communication terminal 200 (200a, 200b, 200c, 200d, 200e), an information processing apparatus 300 (300a, 300b, 300c), a management apparatus 350, a gateway 400, and a management server 500, which are connected with each other wirelessly or by wire. Hereinafter, the communication control apparatuses 100a, 100b, and 100c may be simply referred to the communication control apparatus 100 when difference of the communication control apparatuses 100 may not cause problems for the description, and the communication terminals 200a, 200b, 200c, 200d, and 200e may be simply referred to the communication terminals 200 when difference of the communication terminals 200 may not cause problems for the description.

The communication control apparatus 100 can be connected to a communication path 10 to communicate with the management apparatus 350. The communication path 10 is, for example, a network line that uses a local area network (LAN) without using the Internet. Further, the communication control apparatus 100 and the management apparatus 350 are connected to Internet 450 via the gateway 400. Further, the communication control apparatus 100 and the management apparatus 350 can communicate with the management server 500 via the Internet 450.

The communication control apparatus 100 is disposed in each specific area, such as each room. The communication control apparatus 100 can communicate with the communication terminal 200 and the information processing apparatus 300 using a first communication method in each room, which means the communication terminal 200 and the information processing apparatus 300 can communicate with each other via the communication control apparatus 100 in each specific area. The communication using the first communication method employs, for example, a wireless local area network (LAN) communication using known standards, such as Institute of Electrical and Electronics Engineers (IEEE) 802.11a/b/g/n/ac. The first communication method may be also referred to as a first communication scheme.

The communication control apparatus 100a is disposed in, for example, room A, and controls communication with the communication terminal 200a and the information processing apparatus 300a disposed or located in the room A using the first communication method. Further, the communication control apparatus 100a can communicate with the communication terminal 200a using a second communication method. The communication using the second communication method employs, for example, a short-range wireless communication, such as Bluetooth (trademark) Low Energy (BLE) communication. The communication control apparatus 100a transmits connection information used for performing communication using the first communication method to the communication terminal 200a using the second communication method. The second communication method may be also referred to as a second communication scheme. The second communication method is different from the first communication method.

After the communication terminal 200a receives the connection information, transmitted from the communication control apparatus 100a, the communication terminal 200a uses the connection information to communicate with the communication control apparatus 100a using the first communication method. The connection information used for performing communication using the first communication method includes, for example, a service set identifier (SSID), and a password. With this configuration, the communication control apparatus 100a can restrict the communication partner of the communication using the first communication method only to the communication terminal 200a that has received the connection information from the communication control apparatus 100a using the second communication method.

Similarly, the communication control apparatus 100b is disposed in room B, and controls communication with the communication terminals 200h and 200c, and the information processing apparatus 300b disposed in the room B using the first communication method. The communication control apparatus 100b transmits the connection information used for performing communication using the first communication method to the communication terminals 200b and 200c using the second communication method. The communication terminals 200b and 200c use the connection information, received from the communication control apparatus 100b, to communicate with the communication control apparatus 100b using the first communication method.

Further, the communication control apparatus 100c is disposed in room C, and controls communication with the communication terminals 200d, 200e, and the information processing apparatus 300c disposed in the room C using the first communication method. The communication control apparatus 100c transmits the connection information used for performing communication using the first communication method to the communication terminal 200d and 200e using the second communication method. The communication terminals 200d and 200e use the connection information, received from the communication control apparatus 100c, to communicate with the communication control apparatus 100c using the first communication method.

By contrast, a user carrying the communication terminal 200f is not present in any one of the rooms A, B and C. Therefore, the communication terminal 200f cannot receive the connection information used for performing the communication using the first communication method from any one of the communication control apparatuses 100 by using the second communication method. Therefore, the communication terminal 200f cannot communicate with any one of the communication control apparatuses 100 using the first communication method.

The communication control apparatus 100 is, for example, a wireless LAN router. The communication control apparatus 100 serves as a wireless LAN access point. The communication control apparatus 100 generates the connection information to be used for performing communication with the communication terminal 200 and the information processing apparatus 300 using the first communication method. Then, the communication control apparatus 100 transmits the generated connection information to the communication terminal 200 and the information processing apparatus 300 using the second communication method. Then, based on the connection information transmitted to the communication terminal 200 and the information processing apparatus 300 from the communication control apparatus 100, the communication control apparatus 100 communicates with the communication terminal 200 and the information processing apparatus 300 using the first communication method.

In the above described configuration, the communication control apparatus 100 can serve as the access point of communication using the first communication method. The communication control apparatus 100 is disposed in each room (i.e., specific area), and communicates with the communication terminal 200 and the information processing apparatus 300 located in each room using the first communication method.

The communication terminal 200 is, for example, a smart phone, a mobile phone terminal, a personal computer (PC), and a tablet terminal, and is a terminal device that can be carried by, for example, a teacher or a student. The communication terminal 200 is an example of a communication device such as a portable or mobile communication device.

The information processing apparatus 300, disposed in each room, includes a first communication function using the first communication method, and a second communication function using the second communication method. For example, the information processing apparatus 300a is an interactive white board (IWB) that can perform an interactive communication and display images written on a panel, and the information processing apparatus 300b is a projector (PJ). Further, the information processing apparatus 300c is, for example, a multi-function peripheral (MFP).

However, the information processing apparatus 300 is not limited thereto, and can be a desktop PC or the like. Similar to the communication terminal 200, the information processing apparatus 300 receives the connection information used for performing communication using the first communication method from the communication control apparatus 100 using the second communication method. Then, the information processing apparatus 300 uses the received connection information to communicate with the communication control apparatus 100 using the first communication method.

The management apparatus 350 manages data transmitted and received by the communication control apparatus 100, and authentication information for performing communication. The management apparatus 350 can be connected to the communication path 10 to communicate with the communication control apparatus 100 without using the Internet. The management apparatus 350 is, for example, a PC disposed in a teacher room in the communication control system 1.

The gateway 400 is connected to the Internet 450 to communicate with the management server 500. Further, the gateway 400 is connected to the communication path 10 to communicate with a plurality of communication control apparatuses 100. The gateway 400 transfers data between the plurality of communication control apparatuses 100 and the management server 500, which are connected with each other via the Internet 450. It should be noted that the configuration of the gateway 400 is not limited thereto, and may be implemented by using a dedicated hardware resources and/or software programs.

The management server 500 is connected to the Internet 450 to communicate with the plurality of communication control apparatuses 100. The management server 500 manages or checks the connection information used for performing communication between the communication control apparatus 100 and the communication terminal 200 using the first communication method, and connected-terminal-number information of the communication terminal 200. Further, the management apparatus 350 and the management server 500 can be omitted depending on a system configuration, or any one of the management apparatus 350 and the management server 500 alone can be disposed in the communication control system 1. Further, the communication control system 1 can be applied to any environment including schools. For example, the communication control system 1 can be applied in any environment including specific closed areas, such as company floors or rental conference rooms.

### Outline:

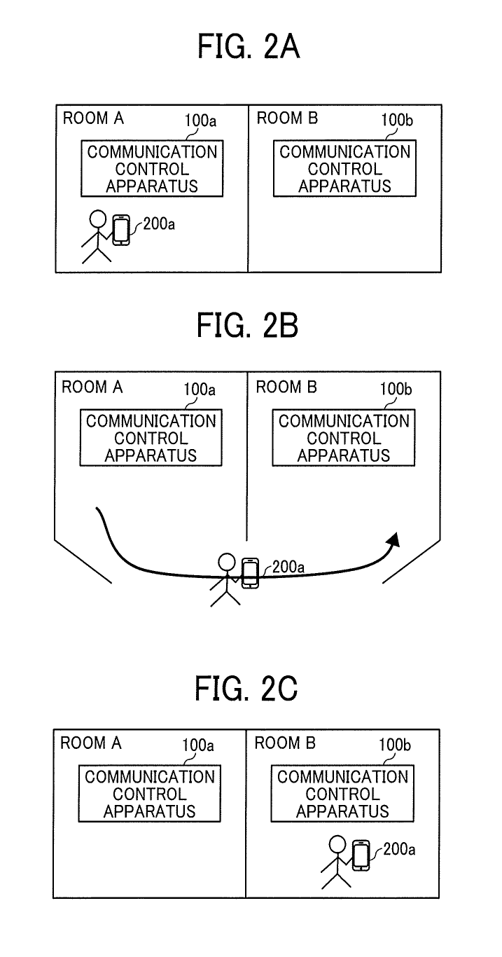

FIG. 2 schematically illustrates an example of a usage of the communication control system 1 of the embodiment. FIG. 2A illustrates a case that a user carrying the communication terminal 200a is present in the room A. In FIG. 2A, communication is established between the communication terminal 200a and the communication control apparatus 100a disposed in the room A using the first communication method. The communication control apparatus 100a has a function of controlling communication using the first communication method in the room A (i.e., specific area). The communication control function is a function serving as an access point of communication using the first communication method. The communication control function may be also referred to as the controlling of communication processing in this description.

The communication terminal 200a receives the connection information used for performing communication using the first communication method from the communication control apparatus 100a using the second communication method. For example, when the second communication method employs the near field communication (NFC), at first, the communication terminal 200a is placed closer to the communication control apparatus 100a equipped with a NFC tag used as a short-range wireless communication unit. Then, the communication terminal 200a receives the connection information from the communication control apparatus 100a via the NFC tag using the NFC communication. Then, the communication control apparatus 100a and the communication terminal 200a use the connection information transmitted and received by using the second communication method to establish communication between the communication control apparatus 100a and the communication terminal 200a using the first communication method. In this system, when a user carrying the communication terminal 200a enters the room A and the communication terminal 200a is placed closer to the communication control apparatus 100a, at first, the communication terminal 200a performs the communication with the communication control apparatus 100a using the second communication method, with which the communication terminal 200a can easily acquire the connection information used for performing communication using the first communication method from the communication control apparatus 100a.

FIG. 2B illustrates a case that the user carrying the communication terminal 200a has left the room A. In FIG. 2B, for example, when the class time in the class A has ended, the user carrying the communication terminal 200a left the room A. When the user carrying the communication terminal 200a left the room A, the communication control apparatus 100a disconnects the communication with the communication terminal 200a using the first communication method.

Specifically, for example, if the second communication method employs the BLE communication, the communication control apparatus 100a determines that the user carrying the communication terminal 200a has left the room A when the BLE communication with the communication terminal 200a is terminated, and then the communication control apparatus 100a disconnects the communication with the communication terminal 200a using the first communication method. Further, for example, if the second communication method employs the NFC communication, the communication control apparatus 100a determines that the user carrying the communication terminal 200a has left the room A when the communication control apparatus 100a detects the NFC communication between the NFC tag (e.g., second communication unit 1502), which may be disposed near the entrance of the room A, and the communication terminal 200a, and then the communication control apparatus 100a disconnects the communication with the communication terminal 200a using the first communication method.

Further, in FIG. 2B, the communication control apparatus 100a deactivates the communication control function based on effective time information 1552 to be described later. In this description, the effective time information 1552 is used as one example of a first condition. When the class time in the class A has ended and the user carrying the communication terminal 200a has left the room A, the communication between the communication terminal 200a and the communication control apparatus 100a using the first communication method is disconnected, but the communication terminal 200a still retains the connection information. That is, even when the user carrying the communication terminal 200a moves to the room B adjacent to the room A, the communication terminal 200a can still communicate with the communication control apparatus 100a by using the connection information stored in the communication terminal 200a using the first connection method even after the class time in the class A ended.

Therefore, the communication control apparatus 100a is configured to deactivate the communication control function of the communication control apparatus 100a based on the effective time information 1552. The effective time information 1552 includes information of time for deactivating the communication control function. When the communication control apparatus 100a deactivates the communication control function, the communication terminal 200a cannot communicate with the communication control apparatus 100a using the first communication method. With this configuration, the communication control system 1 can prevent the unintended communication (e.g., unintended wireless communication) performed between the communication control apparatus 100a and the communication terminal 200a using the first communication method.

Further, the communication control apparatus 100a can be configured not to perform communication using the second communication method when the communication control apparatus 100a deactivates the communication control function. Further, the communication control apparatus 100a can be configured to deactivate the communication function using the second communication method when the communication control apparatus 100a deactivates the communication control function. Further, the communication control apparatus 100a can be configured to delete the connection information used for performing communication using the first communication method in response to a situation that the communication control apparatus 100a deactivates the communication control function.

FIG. 2C illustrates a case that the user carrying the communication terminal 200a, who has left the room A, has entered the room B adjacent to the room A. When the user carrying the communication terminal 200a enters the room B, the communication control apparatus 100b establishes communication with the communication terminal 200a using the first communication method. Specifically, after the communication control apparatus 100b establishes the communication with the communication terminal 200a using the second communication method, the communication control apparatus 100b activates the communication control function. Then, the communication control apparatus 100b generates the connection information used for performing communication using the first communication method, and transmits the generated connection information to the communication terminal 200a using the second communication method. With this configuration, the communication control apparatus 100b can communicate with the communication terminal 200a, which has received the connection information, using the first communication method.

If the communication control apparatus 100b disposed in the room B is already connected to another communication terminal 200 using the first communication method before the user carrying the communication terminal 200a enters the room B, the communication control apparatus 100b has already activated the communication control function. In this case, after the communication control apparatus 100b establishes the communication with the communication terminal 200a using the second communication method, the communication control apparatus 100b transmits the already generated connection information to the communication terminal 200a using the second communication method.

As above described, the communication control system 1 includes the communication control apparatus 100 that controls communication using the first communication method with the communication terminal 200 located in the specific area. At first, the communication control apparatus 100 transmits the connection information used for performing communication using the first communication method to the communication terminal 200 using the second communication method, which is different from the first communication method. Then, the communication control apparatus 100 communicates with the communication terminal 200 using the first communication method based on the connection information transmitted to the communication terminal 200. Further, the communication control apparatus 100 deactivates the communication control function based on the effective time information 1552 indicating information of the time for deactivating the communication control function. With this configuration, the unintended communication (e.g., unintended wireless communication) between the communication control apparatus 100 disposed in each adjacent area and the communication terminal 200 using the first communication method can be prevented.

### Hardware Configuration:

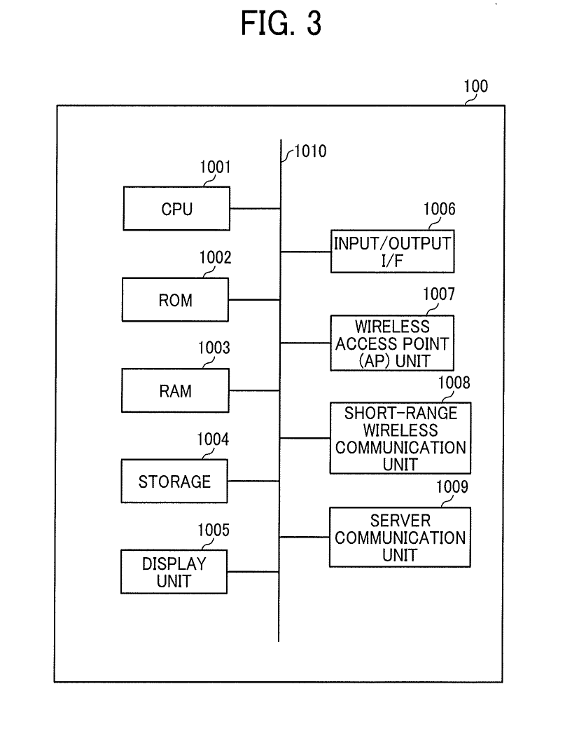

FIG. 3 illustrates an example of a hardware block diagram of the communication control apparatus 100 of the embodiment. The communication control apparatus 100 employs, for example, a general computer configuration. As illustrated in FIG. 3, the communication control apparatus 100 includes for example, a central processing unit (CPU) 1001, a read only memory (ROM) 1002, a random access memory (RAM) 1003, a storage 1004, a display unit 1005, an input/output interface (I/F) 1006, a wireless access point (AP) unit 1007, a short-range wireless communication unit 1008, a server communication unit 1009, and a bus 1010.

The CPU 1001 is a computing device, such as circuitry, that implements the functions of the communication control apparatus 100 by loading programs and data, stored in the ROM 1002 and the storage 1004 in the RAM 1003, and executing the programs and data. The communication control apparatus 100 implements the communication control method of the embodiment by executing the program of the embodiment.

The RAM 1003 is a volatile memory used as a work area of the CPU 1001. The ROM 1002 is a nonvolatile memory capable of retaining programs and data even when a power supply is turned off. The storage 1004 is a storage device, such as a hard disk drive (HDD), a solid state drive (SSD), and a flash ROM, and stores an operating system (OS), application programs, and various data.

The display unit 1005 displays, for example, data related to communication executed by the communication control apparatus 100. Further, the display unit 1005 may be connected to a display interface (I/F) via a cable. The cable may be a cable for analog red-green-blue/video graphics array (RGB/VGA) signals, a cable for component video, or a cable for high definition multimedia interface (HDMI) and digital video interactive (DVI) signals. The input/output I/F 1006 is an interface for connecting a universal serial bus (USB) cable, or various memories, such as a USB memory.

The wireless AP unit 1007 is a communication unit that performs communication using the wireless LAN of known standards, such as the Institute of Electrical and Electronics Engineers (IEEE) 802.11a/b/g/n/ac, and includes, for example, an antenna, a wireless unit, and a media access control (MAC) unit. The wireless AP unit 1007 is used as an access point in communication with the communication terminal 200 or the information processing apparatus 300.

The short-range wireless communication unit 1008 is a communication unit that performs the short-range wireless communication, and includes, for example, an antenna, a wireless unit, and a media access control (MAC) unit. The short-range wireless communication employs, for example, BLE communication. In addition to the BLE communication, the short-range wireless communication can employ the near field communication (NFC), millimeter wave radio communication, QR code (registered trademark), visible light, ambient sound, and ultrasonic wave.

The server communication unit 1009 is a communication unit for communicating with the management apparatus 350 and the management server 500. The bus 1010 is connected to the above components to transmit address signals, data signals, and various control signals. The CPU 1001, the ROM 1002, the RAM 1003, the storage 1004, the display unit 1005, the input/output I/F 106, the wireless AP unit 1007, the short-range wireless communication unit 1008, and the server communication unit 1009 are connected with each other via the bus 1010.

The hardware configuration of the communication control apparatus illustrated in FIG. 3 can be applied to the management apparatus 350 and the management server 500 similarly. In this case, the management apparatus 350 and the management server 500 may, for example, omit the wireless AP unit 1007, and communicate with the communication control apparatus 100 using the server communication unit 1009.

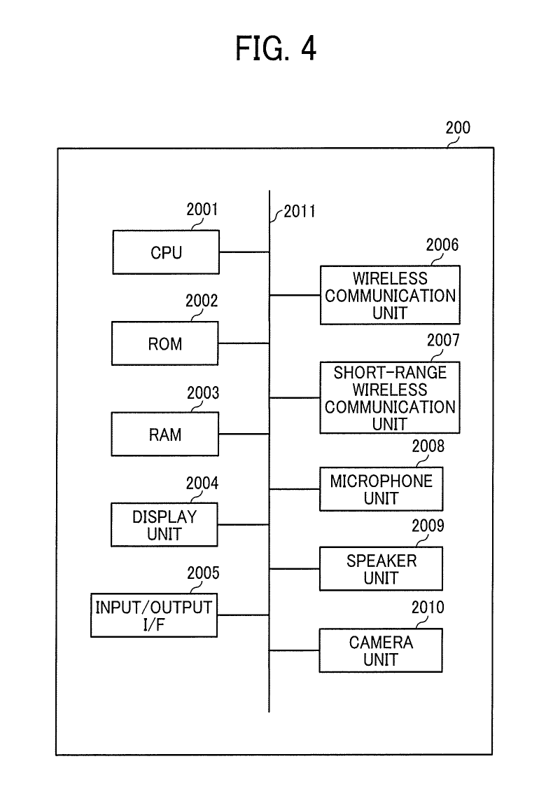

FIG. 4 illustrates an example of a hardware block diagram of the communication terminal 200 of the embodiment. The communication terminal 200 employs, for example, a general computer configuration. As illustrated in FIG. 4, the communication terminal 200 includes, for example, a CPU 2001, a ROM 2002, a RAM 2003, a display unit 2004, an input/output interface (I/F) 2005, a wireless communication unit 2006, a short-range wireless communication unit 2007, a microphone unit 2008, a speaker unit 2009, a camera unit 2010, and a bus 2011.

The CPU 2001 is a computing device, such as circuitry, that implements the functions of the communication terminal 200 by loading programs and data, stored in the ROM 2002, and executing the programs and data. The RAM 2003 is a volatile memory used as a work area of the CPU 2001. The ROM 2002 is a nonvolatile memory capable of retaining programs and data even when a power supply is turned off, and stores an operating system (OS), application programs, and various data.

The display unit 2004 displays, for example, data relating to communication executed by the communication terminal 200. Further, the display unit 2004 may be connected to a display interface (I/F) via a cable. The cable may be a cable for analog red-green-blue/video graphics array (RGB/VGA) signals, a cable for component video, or a cable for high definition multimedia interface (HDMI) and digital video interactive (DVI) signals. The input/output I/F 2005 is an interface for connecting a USB cable, or various memories, such as a USB memory

The wireless communication unit 2006 is a communication unit that performs communication using the wireless LAN of known standards, such as the Institute of Electrical and Electronics Engineers (IEEE) 802.11a/b/g/n/ac, and includes, for example, an antenna, a wireless unit, and a media access control (MAC) unit. The short-range wireless communication unit 2007 is a communication unit that performs the short-range wireless communication, and includes, for example, an antenna, a wireless unit, and a media access control (MAC) unit.

The microphone unit 2008, the speaker unit 2009, and the camera unit 2010 are devices for inputting and outputting images and sound. The bus 2011 is connected to the above components to transmit address signals, data signals, and various control signals. The CPU 2001, the ROM 2002, the RAM 2003, the display unit 2004, the input/output TIP 2005, the wireless communication unit 2006, the short-range wireless communication unit 2007, the microphone unit 2008, the speaker unit 2009, and the camera unit 2010 are connected with each other via the bus 2011.

The hardware configuration of the communication terminal 200 illustrated in FIG. 4 can be applied to the information processing apparatus 300 similarly. The hardware configurations illustrated in FIGS. 3 and 4 can be used in each of the embodiments while components may be added or removed as needed.

### First Embodiment

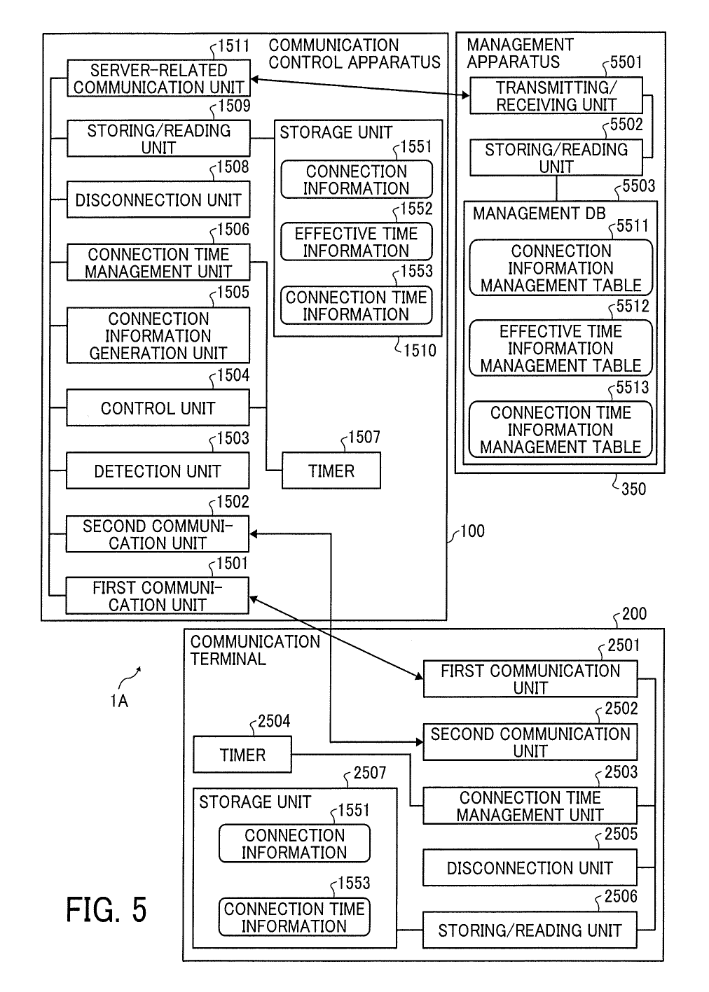

Hereinafter, a description is given of a functional configuration of a communication control system 1A of a first embodiment disposed in each room illustrated in FIG. 1 with reference to FIG. 5. FIG. 5 illustrates an example of a functional block diagram of the communication control system 1A of the first embodiment including the communication control apparatus 100, the communication terminal 200, and the management apparatus 350. The management server 500 is configured to perform functions similar to functions of the management apparatus 350. Further, the communication control apparatus 100 (100a, 100b, 100c) disposed in each room includes common functions, and the communication terminal 200 (200a, 200b, 200c, 200d, 200e) disposed in each room includes common functions.

As illustrated in FIG. 5, the functions implemented by the communication control apparatus 100 includes, for example, a first communication unit 1501, a second communication unit 1502, a detection unit 1503, a control unit 1504, a connection information generation unit 1505, a connection time management unit 1506, a timer 1507, a disconnection unit 1508, a storing/reading unit 1509, a storage unit 1510, and a server-related communication unit 1511.

The first communication unit 1501 communicates with the communication terminal 200 using the first communication method. Specifically, the first communication unit 1501 establishes communication with the communication terminal 200 using connection information 1551 to be described later. The communication using the first communication method is, for example, a wireless LAN communication. The first communication unit 1501 is implemented by, for example, the wireless AP unit 1007 and executing programs using the CPU 1001 illustrated in FIG. 3. The first communication unit 1501 is an example of a communication unit.

The second communication unit 1502 communicates with the communication terminal 200 using the second communication method. The communication using the second communication method is a communication using the short-range wireless communication standard, such as BLE communication. In addition to the BLE communication, the communication using the second communication method can employ the near field communication (NFC), millimeter wave radio communication, QR code (registered trademark), visible light, ambient sound, and ultrasonic wave.

The second communication unit 1502 transmits the connection information 1551 to the communication terminal 200 using the second communication method. To be described later, the connection information 1551 used for performing communication using the first communication method is generated by the connection information generation unit 1505. That is, the communication control apparatus 100 can communicate with the communication terminal 200, which has received the connection information 1551 using the second communication method, using the first communication method. Further, the second communication unit 1502 transmits connection time information 1553, to be described later, to the communication terminal 200 using the second communication method. In this description, the connection time information 1553 is used as one example of a second condition. The second communication unit 1502 is implemented by, for example, the short-range wireless communication unit 1008 and executing programs using the CPU 1001 illustrated in FIG. 3. The second communication unit 1502 is an example of a transmission unit.

The detection unit 1503 detects that the communication using the second communication method by the second communication unit 1502 is established. The detection unit 1503 is implemented by, for example, the short-range wireless communication unit 1008 and executing programs using the CPU 1001 illustrated in FIG. 3.

The control unit 1504 controls the communication control function of the communication control apparatus 100. The communication control function is a function for serving as an access point of communication using the first communication method. The control unit 1504 is implemented by, for example, executing programs using the CPU 1001 illustrated in FIG. 3. For example, when the detection unit 1503 detects that the communication using the second communication method with the communication terminal 200 is established, the control unit 1504 activates the communication control function. On the other hand, the control unit 1504 deactivates the communication control function based on, for example, the effective time information 1552 to be described later.

The effective time information 1552 includes, for example, deactivation time information used for deactivating the communication control function of the communication control apparatus 100. Specifically, the effective time information 1552 includes deactivation time information such as a deactivation time period used for deactivating the communication control function of the communication control apparatus 100, and may further include the deactivation time information such as a deactivation time point used for deactivating the communication control function of the communication control apparatus 100.

The effective time information 1552 further includes activation time information used for activating the communication control function of the communication control apparatus 100. Specifically, the effective time information 1552 includes the activation time information such as an activation time period used for activating the communication control function of the communication control apparatus 100 (i.e., time period not deactivating the communication control function of the communication control apparatus 100), and may further include the activation time information such as an activation time point used for activating the communication control function of the communication control apparatus 100 (i.e., time point not deactivating the communication control function of the communication control apparatus 100).

When the control unit 1504 activates the communication control function, the control unit 1504 starts to measure an activation time of the communication control function. Specifically, when the control unit 1504 activates the communication control function, the control unit 1504 starts to measure the activation time of the communication control function using the timer 1507. Then, the control unit 1504 compares the effective time information 1552 stored in the storage unit 1510 and the activation time measured by the timer 1507. The activation time measured by the timer 1507 indicates a time period that has elapsed from a time point of starting the measurement to the current time, or a time point currently detected or measured by the timer 1507.

When the measured activation time exceeds an effective time (i.e., effective time range) included in the effective time information 1552, that is, when the measured activation time has elapsed the effective time included in the effective time information 1552, the control unit 1504 deactivates the communication control function of the communication control apparatus 100. On the other hand, when the measured activation time is within a range of the effective time included in the effective time information 1552, the control unit 1504 maintains the activation of the communication control function of the communication control apparatus 100.

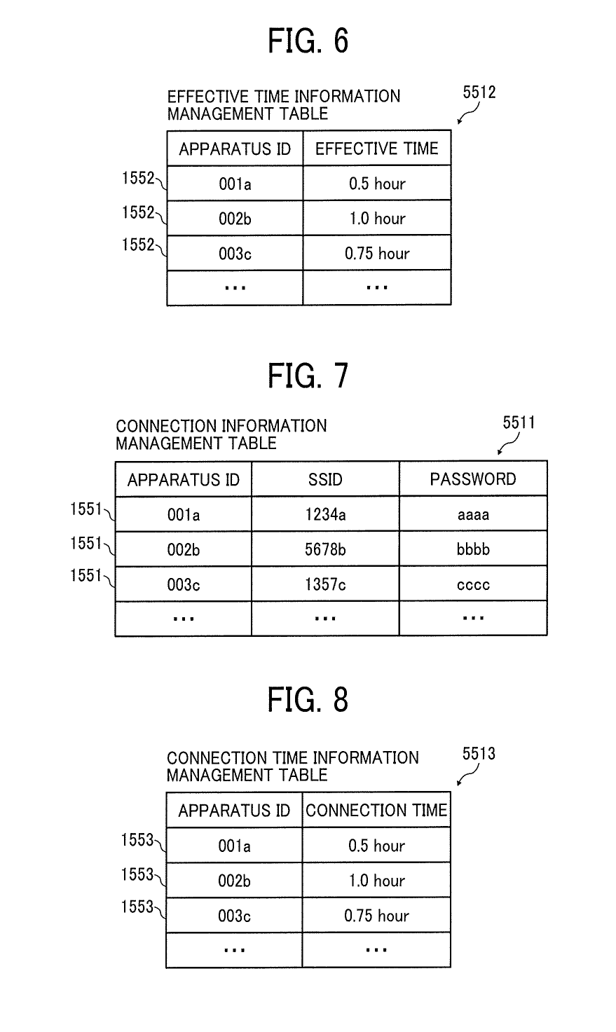

Hereinafter, a description is given of details of the effective time information 1552 with reference to FIG. 6. FIG. 6 illustrates an example of the effective time information 1552. FIG. 6 illustrates an example of an effective time information management table 5512 stored in a management DB 5503 of the management apparatus 350 or the management server 500 to described later. The effective time information management table 5512 associates the effective time of the communication control function of each communication control apparatus 100 with each apparatus ID identifying each communication control apparatus 100 to manage the effective time information 1552.

For example, when the control unit 1504 of the communication control apparatus 100 having the apparatus ID of “001a” activates the communication control function, the control unit 1504 starts to measure the activation time using the timer 1507. Then, when 30 minutes have elapsed from the start of connection (i.e., from the start of measurement of activation time), the control unit 1504 deactivates the communication control function of the communication control apparatus 100. That is, the communication control apparatus 100 having the apparatus ID of “001a” maintains the activation of the communication control function for 30 minutes. Similarly, the communication control apparatus 100 having the apparatus ID of “002b” maintains the activation of the communication control function for 1 hour. Similarly, the communication control apparatus 100 having the apparatus ID of “003c” maintains the activation of the communication control function for 45 minutes.

The effective time information 1552 of the communication control apparatus 100 is stored in the storage unit 1510 of each communication control apparatus 100. Further, the management apparatus 350 or the management server 500 associates the effective time information 1552 of each communication control apparatus 100 with the apparatus ID identifying each communication control apparatus 100, and stores the associated information in the management DB 5503 as the effective time information management table 5512 as illustrated in FIG. 6.

The connection information generation unit 1505 generates the connection information 1551 used for performing communication using the first communication method. When the communication control function of the communication control apparatus 100 is activated, the connection information generation unit 1505 generates the connection information 1551. The connection information generation unit 1505 is implemented by, for example, executing programs using the CPU 1001 illustrated in FIG. 3.

Hereinafter, a description is given of the connection information 1551 generated by the connection information generation unit 1505 with reference to FIG. 7. FIG. 7 illustrates an example of the connection information 1551. FIG. 7 illustrates a connection information management table 5511 stored in the management DB 5503 of the management apparatus 350 or the management server 500. The connection information management table 5511 manages the connection information 1551 of each communication control apparatus 100 identified by each apparatus ID. The connection information 1551 is set to the communication terminal 200 carried by a user who has entered a room (i.e., specific area) disposed with the communication control apparatus 100 so that the communication terminal 200 can communicate with the communication control apparatus 100 disposed in the room (i.e., specific area) using the first communication method. The connection information 1551 includes the identification information identifying the communication control apparatus 100, such as a combination of an apparatus ID, a service set identifier (SSID) and a password.

The connection information generation unit 1505 of the communication control apparatus 100 generates the connection information 1551 related to the apparatus ID of the communication control apparatus 100 (i.e., the connection information generation unit 1505 of a specific communication control apparatus 100 generates specific connection information for the specific communication control apparatus 100), and transmits the generated connection information 1551 to the management apparatus 350 or the management server 500. The management apparatus 350 or the management server 500 collectively stores the connection information 1551 transmitted from each communication control apparatus 100 in the management DB 5503 as the connection information management table 5511 as illustrated in FIG. 7.

The connection time management unit 1506 manages a connection time between the communication control apparatus 100 and the communication terminal 200 based on the connection information 1551 generated by the connection information generation unit 1505. The connection time management unit 1506 manages or checks the connection time between the communication control apparatus 100 and the communication terminal 200 based on the connection time information 1553 stored in the storage unit 1510 and information of the activation time measured by the timer 1507. The connection time information 1553 is to be described later with reference to FIG. 8.

Specifically, when the communication between the communication control apparatus 100 and the communication terminal 200 using the first communication method is established, the connection time management unit 1506 starts to measure the connection time with the communication terminal 200 using the timer 1507. Then, the connection time management unit 1506 compares the connection time measured by the timer 1507 and the connection time included in the connection time information 1553. The connection time information 1553 is generated by the communication control apparatus 100, the management apparatus 350 or the management server 500, and can be set and changed as needed.

Hereinafter, a description is given of details of the connection time information 1553 with reference to FIG. 8. FIG. 8 illustrates an example of the connection time information 1553. FIG. 8 illustrates an example of a connection time information management table 5513 stored in the management DB 5503 of the management apparatus 350 or the management server 500. The connection time information management table 5513 associates the connection time between the communication control apparatus 100 and the communication terminal 200 with each apparatus ID identifying each communication control apparatus 100 to manage the connection time information 1553.

For example, when the connection time management unit 1506 of the communication control apparatus 100 having the apparatus ID of “001a” establishes the communication with the communication terminal 200 using the first communication method, the connection time management unit 1506 starts to measure the connection time using the timer 1507. Then, when 30 minutes have elapsed from the start of connection (i.e. from the start of measurement of connection time), the connection time management unit 1506 instructs the disconnection unit 1508, to be described later, to disconnect the established communication using the first communication method. That is, the communication control apparatus 100 having the apparatus ID of “001a” can be connected with the communication terminal 200 for 30 minutes.

Similarly, the communication control apparatus 100 having the apparatus ID of “002b” can be connected with the communication terminal 200 for 1 hours. Similarly, the communication control apparatus 100 having the apparatus ID of “003c” can be connected with the communication terminal 200 for 45 minutes. The connection time information 1553 of each communication control apparatus 100 is stored in the storage unit 1510 of each communication control apparatus 100 while the management apparatus 350 or the management server 500 collectively stores the connection time information 1553 of each communication control apparatus 100 in the management DB 5503 as the connection time information management table 5513 as illustrated in FIG. 8. As above described, the connection time information 1553 indicates, for example, a time period or duration that the communication control apparatus 100 and the communication terminal 200 can be connected with each other.

The disconnection unit 1508 disconnects the communication between the communication control apparatus 100 and the communication terminal 200 using the first communication method. For example, when a user carrying the communication terminal 200 has left a room (i.e., specific area) where the communication control apparatus 100 is disposed, the disconnection unit 1508 disconnects the communication established between the communication control apparatus 100 and the communication terminal 200, carried by the user that has left the room, using the first communication method.

Further, when the connection time management unit 1506 determines that the connection time between the communication control apparatus 100 and the communication terminal 200 has exceeded the connection time included in the connection time information 1553, the disconnection unit 1508 disconnects the communication established between the communication control apparatus 100 and the communication terminal 200 using the first communication method. The disconnection unit 1508 is implemented by, for example, the wireless AP unit 1007 and executing programs using the CPU 1001 illustrated in FIG. 3.

The storing/reading unit 1509 stores various data in the storage unit 1510, and reads various data from the storage unit 1510. The storing/reading unit 1509 is implemented by, for example, the ROM 1002, the storage 1004, and executing programs using the CPU 1001 illustrated in FIG. 3.

As illustrated in FIG. 5, the storage unit 1510 stores the effective time information 1552 (FIG. 6), the connection information 1551 (FIG. 7), and the connection time information 1553 (FIG. 8). The storage unit 1510 is implemented by, for example, the ROM 1002 and the storage 1004 illustrated in FIG. 3.

The server-related communication unit 1511 performs a function of transmitting and receiving various data to or from the management apparatus 350 or the management server 500. The server-related communication unit 1511 communicates with the management apparatus 350 via the communication path 10. Further, the server-related communication unit 1511 communicates with the management server 500 via the gateway 400 and the Internet 450. The server-related communication unit 1511 is implemented by, for example, the server communication unit 1009 and executing programs using the CPU 1001 illustrated in FIG. 3.

Hereinafter, a description is given of a functional configuration of the communication terminal 200. As illustrated in FIG. 5, the functions implemented by the communication terminal 200 includes, for example, a first communication unit 2501, a second communication unit 2502, a connection time management unit 2503, a timer 2504, a disconnection unit 2505, a storing/reading unit 2506, and a storage unit 2507.

The first communication unit 2501 performs communication with the communication control apparatus 100 using the first communication method. The first communication unit 2501 is implemented by, for example, the wireless communication unit 2006 and executing programs using the CPU 2001 illustrated in FIG. 4.

The second communication unit 2502 performs communication with the communication control apparatus 100 using the second communication method. The second communication unit 2502 receives the connection information 1551 and the connection time information 1553 used for performing communication using the first communication method, which are transmitted from the communication control apparatus 100 by using the second communication method. The second communication unit 2502 is implemented by, for example, the short-range wireless communication unit 2007 and executing programs using the CPU 2001 illustrated in FIG. 4.

The connection time management unit 2503 controls communication with the communication control apparatus 100 using the first communication method based on the connection time information 1553 transmitted from the communication control apparatus 100. Specifically, the connection time management unit 2503 manages or checks the connection time with the communication control apparatus 100 based on a comparison of the connection time information 1553, transmitted from the communication control apparatus 100 and stored in the storage unit 2507, and the communication time with the communication control apparatus 100 measured by the timer 2504. The connection time management unit 2503 is implemented by, for example, executing programs using the CPU 2001 illustrated in FIG. 4.

The disconnection unit 2505 disconnects the communication established with the communication control apparatus 100 using the first communication method. For example, when a user carrying the communication terminal 200 has left a room (i.e., specific area) where the communication control apparatus 100 is disposed, the disconnection unit 2505 disconnects the communication established with the communication control apparatus 100 using the first communication method. Further, when the connection time management unit 2503 determines that the connection time with the communication control apparatus 100 exceeds a given connection time (e.g., threshold connection time) included in the connection time information 1553, the disconnection unit 2505 disconnects the communication established with the communication control apparatus 100 using the first communication method. The disconnection unit 2505 is implemented by, for example, the wireless communication unit 2006 and executing programs using the CPU 2001 illustrated in FIG. 4.

The functions of the connection time management unit 2503, the timer 2504, and the disconnection unit 2505 are similar to the functions implemented by the connection time management unit 1506, the timer 1507, and the disconnection unit 1508 of the communication control apparatus 100, and these functions may be provided on at least one of the communication control apparatus 100 and the communication terminal 200.

The storing/reading unit 2506 stores various data in the storage unit 2507, and reads various data from the storage unit 2507. The storing/reading unit 2506 is implemented by, for example, the ROM 2002 and executing programs using the CPU 2001 illustrated in FIG. 4. The storage unit 2507 stores the connection information 1551 and the connection time information 1553 transmitted from the communication control apparatus 100. The storage unit 2507 is implemented by, for example, the ROM 2002 illustrated in FIG. 4.

Hereinafter, a description is given of a functional configuration of the management apparatus 350. As illustrated in FIG. 5, the functions implemented by the management apparatus 350 includes, for example, a transmitting/receiving unit 5501, a storing/reading unit 5502, and a management database (DB) 5503. The transmitting/receiving unit 5501 performs transmission and reception of data to and from the communication control apparatus 100. The transmitting/receiving unit 5501 is implemented by, for example, the server communication unit 1009 and executing programs using the CPU 1001 illustrated in FIG. 3.

The storing/reading unit 5502 stores various data in the management DB 5503, and reads various data from the management DB 5503. The storing/reading unit 5502 is implemented by, for example, the ROM 1002, the storage 1004, and executing programs using the CPU 1001 illustrated in FIG. 3. As illustrated in FIG. 5, the management DB 5503 stores the effective time information management table 5512 (FIG. 6), the connection information management table 5511 (FIG. 7), and the connection time information management table 5513 (FIG. 8).

### Connection Processing:

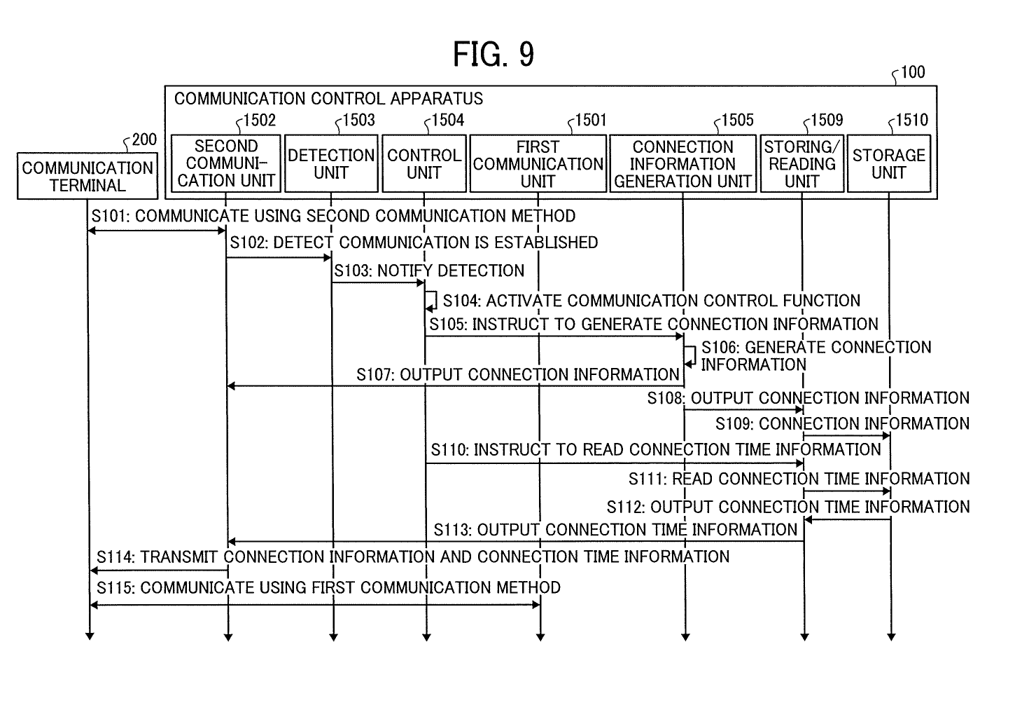

FIG. 9 is an example of a sequence diagram illustrating a connection processing of the communication control apparatus 100 and the communication terminal 200 in the communication control system 1A of the first embodiment. The connection processing of the communication control apparatus 100 and the communication terminal 200 illustrated in FIG. 9 describes an example case when a user carrying the communication terminal 200a enters the room A disposed with the communication control apparatus 100a as illustrated in FIG. 1. In this example case, it is assumed that the communication terminal 200 does not exist in the room A at first, and the communication control function of the communication control apparatus 100a is in an idle mode (not activated) before the user carrying the communication terminal 200a enters the room A

In step S101, the second communication unit 1502 of the communication control apparatus 100a communicates with the communication terminal 200a using the second communication method. When the user carrying the communication terminal 200a enters the room A, the communication terminal 200a can communicate with the communication control apparatus 100a using the second communication method.

In step S102, the detection unit 1503 of the communication control apparatus 100a detects that the communication between the second communication unit 1502 and the communication terminal 200 using the second communication method is established.

In step S103, after the detection unit 1503 of the communication control apparatus 100a detects the communication with the communication terminal 200a using the second communication method, the detection unit 1503 notifies the detection of establishment of the second communication to the control unit 1504.

In step S104, the control unit 1504 of the communication control apparatus 100a activates the communication control function because there is no communication terminal 200 being connected with the communication control apparatus 100a using the first communication method.

In step S105, after the control unit 1504 of the communication control apparatus 100a activates the communication control function, the control unit 1504 outputs an instruction for generating the connection information 1551 to be used for performing the communication using the first communication method to the connection information generation unit 1505.

In step S106, the connection information generation unit 1505 of the communication control apparatus 100a generates the connection information 1551 to be used for performing the communication using the first communication method based on the generation instruction of the connection information 1551 received from the control unit 1504.

In step S107, the connection information generation unit 1505 of the communication control apparatus 100a outputs the generated connection information 1551 to the second communication unit 1502.

In step S108, the connection information generation unit 1505 of the communication control apparatus 100a outputs the generated connection information 1551 to the storing/reading unit 1509.

In step S109, the storing/reading unit 1509 of the communication control apparatus 100a stores the connection information 1551 in the storage unit 1510. It should be noted that step S107 can be performed before or after performing step S108 and step S109.

In step S110, the control unit 1504 of the communication control apparatus 100a instructs the storing/reading unit 1509 to read the connection time information 1553.

In step S111, the storing/reading unit 1509 of the communication control apparatus 100a reads the connection time information 1553 stored in the storage unit 1510.

In step S112, the storage unit 1510 of the communication control apparatus 100a outputs the stored connection time information 1553 to the storing/reading unit 1509.

In step S113, the storing/reading unit 1509 of the communication control apparatus 100a outputs the connection time information 1553 to the second communication unit 1502.

In step S114, the second communication unit 1502 of the communication control apparatus 100a transmits the connection information 1551 and the connection time information 1553 to the communication terminal 200a using the communication established using the second communication method.

In step S115, the first communication unit 1501 of the communication control apparatus 100a communicates with the communication terminal 200a using the first communication method using the connection information 1551 transmitted from second communication unit 1502. After the communication terminal 200a receives the connection information 1551 from the second communication unit 1502, the communication terminal 200a uses the received connection information 1551 to set connection settings of the communication using the first communication method. Then, the communication terminal 200a establishes the communication with the communication control apparatus 100a using the first communication method.

### Disconnection Processing and Deactivation Processing:

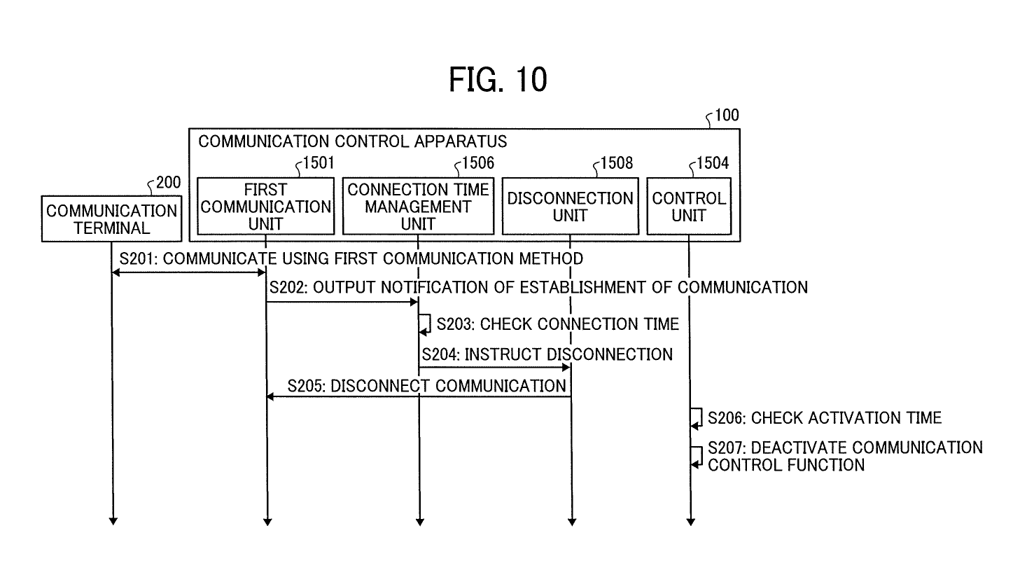

Hereinafter, a description is given of the disconnection processing of the communication using the first communication method, and the deactivation processing of the communication control function of the communication control apparatus 100 in the communication control system 1A of the first embodiment with reference to FIG. 10. FIG. 10 illustrates an example of a sequence diagram illustrating the disconnection processing of the communication using the first communication method and the deactivation processing of the communication control function in the communication control system 1A of the first embodiment. FIG. 10 illustrates an example case that a user carrying the communication terminal 200a, who has entered the room A, uses the communication terminal 200a establishing the communication with the communication control apparatus 100a using the first communication method as illustrated in FIG. 9, and then leaves the room A.

In step S201, the first communication unit 1501 of the communication control apparatus 100a establishes the communication with the communication terminal 200a using the first communication method. The process of establishing the communication between the communication control apparatus 100a and the communication terminal 200a using the first communication method can be performed using the sequence illustrated in FIG. 9.

In step S202, after the communication between the communication control apparatus 100a and the communication terminal 200a using the first communication method is established, the first communication unit 1501 of the communication control apparatus 100a outputs a notification indicating that the communication is established to the connection time management unit 1506.

In step S203, the connection time management unit 1506 of the communication control apparatus 100a manages or checks the connection time of the communication established between the communication control apparatus 100a and the communication terminal 200a using the first communication method. Specifically, when the communication between the communication control apparatus 100a and communication terminal 200a is established using the first communication method, the connection time management unit 1506 starts to measure the connection time using the timer 1507. Further, the connection time management unit 1506 reads the connection time information 1553 stored in the storage unit 1510, and compares the connection time (e.g., threshold connection time) included in the connection time information 1553 and the connection time measured by the timer 1507.

In step S204, if the connection time measured by the timer 1507 exceeds the connection time (e.g., threshold connection time) included in the connection time information 1553, the connection time management unit 1506 of the communication control apparatus 100a outputs a disconnection instruction of the communication between the communication control apparatus 100a and the communication terminal 200a using the first communication method to the disconnection unit 1508.

In step S205, the disconnection unit 1508 of the communication control apparatus 100a disconnects the communication between the communication control apparatus 100a and the communication terminal 200a using the first communication method.

In steps S203 to S205, the communication between the communication control apparatus 100a and the communication terminal 200a using the first communication method is terminated or disconnected based on the connection time information 1553, but not limited thereto. For example, if the user carrying the communication terminal 200a leaves the room A (i.e., specific area) within a range of the connection time included in the connection time information 1553, the disconnection unit 1508 disconnects the communication between the communication control apparatus 100a and the communication terminal 200a using the first communication method without waiting of elapsing of the connection time included in the connection time information 1553.

In step S206, the control unit 1504 of the communication control apparatus 100a manages or checks the activation time of the communication control function. Specifically, when the control unit 1504 activates the communication control function, the control unit 1504 starts to measure the activation time using the timer 1507. Then, the control unit 1504 compares the effective time information 1552 stored in the storage unit 1510 and the activation time measured by the timer 1507. The effective time information 1552 is information related to the time for deactivating the communication control function of the communication control apparatus 100. Specifically, the effective time information 1552 includes time information such as the time period for deactivating the communication control function of the communication control apparatus 100.

In step S207, if the measured activation time exceeds the effective time included in the effective time information 1552, the control unit 1504 deactivates the communication control function of the communication control apparatus 100a. On the other hand, if the measured activation time is still within a range of the effective time included in the effective time information 1552, the control unit 1504 maintains the activation of the communication control function of the communication control apparatus 100a. With this configuration, the communication control apparatus 100a can deactivate the communication control function of the communication control apparatus 100 based on the effective time information 1552, and thereby the communication control apparatus 100 can prevent the unintended communication (e.g., unintended wireless communication) with the communication terminal 200 using the first communication method, for example, when the class time in one room (i.e., specific area) disposed with the communication control apparatus 100 is ended.

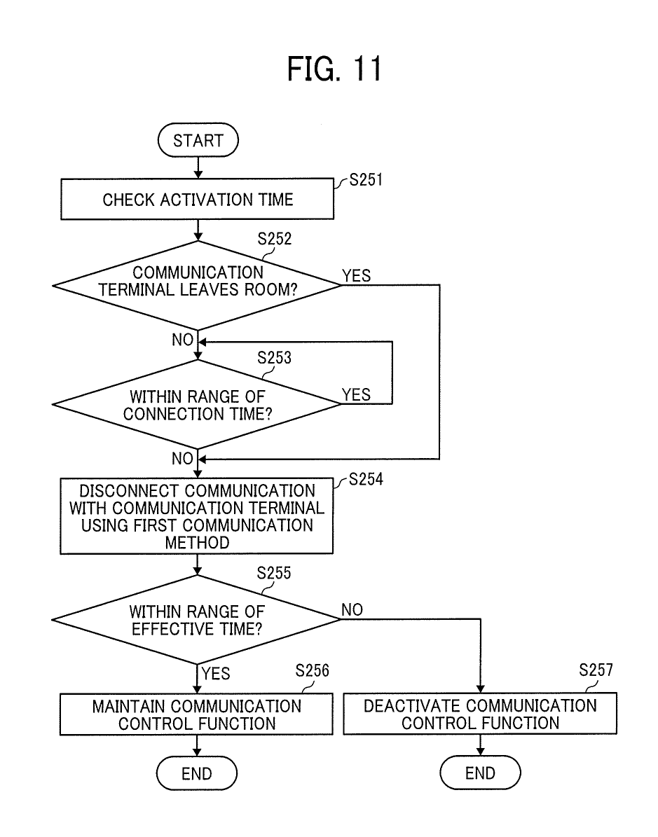

Hereinafter, a description is given of processing of the communication control apparatus 100a in detail with reference to FIG. 11. FIG. 11 illustrates an example of a flowchart illustrating the steps of the disconnection processing of the communication using the first communication method and the deactivation processing of the communication control function in the communication control system 1A of the first embodiment. As same as the example case of FIG. 9, it is assumed that the communication between the communication control apparatus 100a and the communication terminal 200a is already established using the first communication method.

At first, in step S251, when the control unit 1504 of the communication control apparatus 100a activates the communication control function, the control unit 1504 starts to manage or check the activation time. Specifically, when the control unit 1504 activates the communication control function, the control unit 1504 starts to measure the activation time using the timer 1507. Then, the control unit 1504 compares the effective time information 1552 stored in the storage unit 1510 and the activation time measured by the timer 1507.

In step S252, the control unit 1504 determines whether the communication terminal 200a has left the room A. If the communication terminal 200a is still in the room A (S252: NO), the sequence proceeds to step S253. On the other hand, when the user carrying the communication terminal 200a has left the room A (S252: YES), the sequence proceeds to step S254.

If the user carrying the communication terminal 200a has left the room A (S252: YES), in step S254, the communication control apparatus 100a disconnects the communication with the communication terminal 200a using the first communication method.

In this processing, whether or not the user carrying the communication terminal 200a has left the room A is determined based on whether the communication control apparatus 100a detects the communication using the second communication method. For example, if the second communication method employs the BLE communication, the communication control apparatus 100a determines that the user carrying the communication terminal 200a has left the room A when the communication control apparatus 100a detects the disconnection of the communication established with the communication terminal 200a using the BLE communication. Further, for example, if the second communication method employs the NFC communication, the communication control apparatus 100a determines that the user carrying the communication terminal 200a has left the room A when the communication control apparatus 100a detects the NFC communication between the communication terminal 200a and the NFC tag (e.g., second communication unit 1502) disposed near the entrance of the room A. The NFC communication between the communication terminal 200a and the NFC tag disposed near the entrance of the room A can be used to detect when the user carrying the communication terminal 200 has entered or left the room.

In step S253, after the communication with the communication terminal 200a using the first communication method is established, the communication control apparatus 100a reads the connection time information 1553 stored in the storage unit 1510. Further, when the communication between the communication control apparatus 100a and the communication terminal 200a using the first communication method is established, the communication control apparatus 100a starts to measure the connection time using the timer 1507.

In step S253, if the connection time measured by the timer 1507 is within the range of connection time included in the connection time information 1553 (S253: YES), the communication control apparatus 100a repeats the processing of step S253. On the other hand, if the connection time measured by the timer 1507 exceeds the connection time included in the connection time information 1553 (S253: NO), the sequence proceeds to step S254. The measurement of the connection time using the timer 1507 is started at a time when the communication between the communication control apparatus 100a and communication terminal 200a using the first communication method is detected. Further, the measurement of connection time using the timer 1507 can be started based on a pre-set time or timing.

If the connection time measured by the timer 1507 exceeds the connection time included in the connection time information 1553 (S253: NO), in step S254, the communication control apparatus 100a disconnects the communication with the communication terminal 200a using the first communication method.

In step S255, the control unit 1504 determines whether the activation time measured by the timer 1507 is within the range of the effective time included in the effective time information 1552. If the activation time measured by the timer 1507 is within the range of the effective time included in the effective time information 1552 (S255: YES), the control unit 1504 proceeds the sequence to step S256. On the other hand, If the activation time measured by the timer 1507 exceeds the range of the effective time included in the effective time information 1552, the control unit 1504 proceeds the sequence to step S257.

In step S256, the control unit 1504 of the communication control apparatus 100a maintains the activation of the communication control function because the activation time is still within the range of effective time included in the effective time information 1552.

In step S257, the control unit 1504 of the communication control apparatus 100a deactivates the communication control function because the activation time measured by the timer 1507 has exceeded the range of effective time included in the effective time information 1552. Further, if a user carrying any one of the communication terminals 200 enters the room A (i.e., specific area) after the communication control apparatus 100a deactivates the communication control function in step S257, and the communication control apparatus 100a establishes the communication with the communication terminal 200 using the second communication method again, the communication control apparatus 100a activates the communication control function again.

As to the above described first embodiment, the communication control apparatus 100 is equipped with the communication control function that controls the communication using the first communication method with the communication terminal 200 located in the specific area, and transmits the connection information 1551 used for performing the communication using the first communication method to the communication terminal 200 using the second communication method different from the first communication method. The communication control apparatus 100 uses the connection information 1551, transmitted to the communication terminal 200, to communicate with the communication terminal 200 using the first communication method. Then, the communication control apparatus 100 deactivates the communication control function based on the effective time information 1552 related to the time for deactivating the communication control function of the communication control apparatus 100. With this configuration, the communication control apparatus 100 can prevent the unintended communication (e.g., unintended wireless communication) with the communication terminal 200 using the first communication method.

### Variant Example of First Embodiment

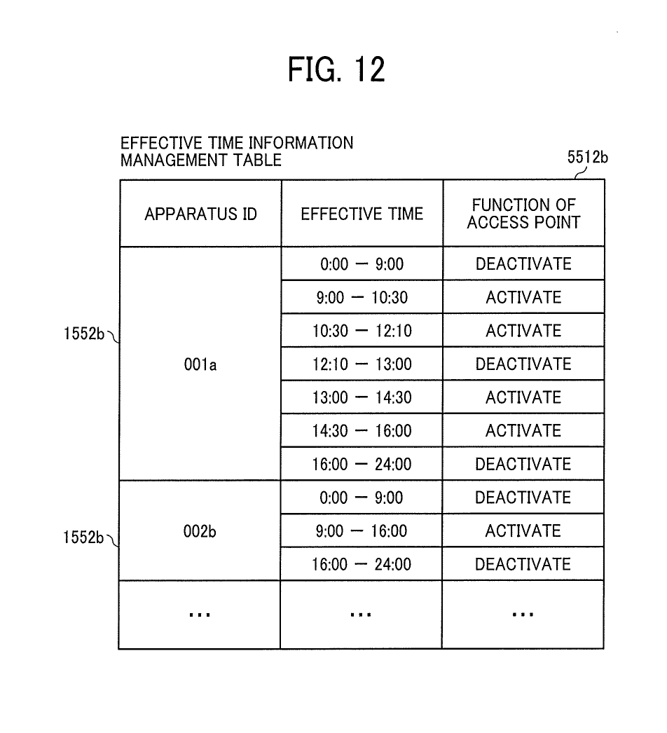

Hereinafter, a description is given of a variant example of the first embodiment with reference to FIG. 12. As to the communication control system of the variant example of the first embodiment, effective time information 1552b includes time information related to the activation time and the deactivation time of the communication control function. FIG. 12 illustrates an example of the effective time information 1552b of the variant example of the first embodiment. FIG. 12 illustrates an example of an effective time information management table 5512b stored in the management DB 5503 of the management apparatus 350. The effective time information management table 5512b associates the communication control function (e.g., function of access point) and the effective time of the communication control function set for each communication control apparatus 100 identified by the apparatus ID to manage the associated information as the effective time information 1552b, which is one example of the first condition.

The effective time information 1552b includes, for example, time information such as an activation time point or period used for activating the communication control function of the communication control apparatus 100 (i.e., time point or period not deactivating the communication control function of the communication control apparatus 100), and time information such as a deactivation time point or period used for deactivating the communication control function of the communication control apparatus 100 For example, the effective time information 1552b of the apparatus ID of “001a” is set by assuming that the communication control system 1A is used in each room of a school, in which the effective time information 1552b of the apparatus ID of “001a” is prepared based on a class time schedule in one room. The communication control apparatus 100, which corresponds to the apparatus ID of “001a,” activates the communication control function when the current time becomes the start time (9:00 AM), and maintains the communication control function during the first period (9:00 to 10:30 AM) and the second period (10:30 AM to 12:10 PM). Then, the communication control apparatus 100 corresponding to the apparatus ID of “001a” deactivates the communication control function when the current time becomes a lunch break (12:10 to 13:00 PM), and the communication control apparatus 100 activates the communication control function again when the current time becomes the start time of the third period (13:00 to 14:30 PM). Finally, when the current time passes the end time of the fourth period (14:30 to 16:00 PM), the communication control apparatus 100 corresponding to the apparatus ID of “001a” deactivates the communication control function (16:00 PM to 24:00, 0:00 to 9:00 AM), and the classes in one day is ended. As to the above described communication control apparatus 100, the time information includes, for example, an activation time point or period to activate (not to deactivate) the communication control function (controlling of communication processing), and the communication control apparatus 100 deactivates the communication control function when the current time being measured deviates from the activation time point or period. Further, as to the above described communication control apparatus 100, the time information includes, for example, an activation time period or period to activate (not to deactivate) the communication control function, and the communication control apparatus 100 deactivates the communication control function when the current time being measured deviates from the activation time period or period.

On the other hand, for example, as indicated in the effective time information 1552b, the communication control apparatus 100 corresponding to the apparatus ID of “002b” can be configured to activate the communication control function continuously (i.e., not to deactivate the communication control function) during the daytime time period (9:00 AM to 16:00 PM) when the class activities are being continued. In this manner, the effective time of the communication control function can be set variably based on the timeline or schedule of the room disposed with the communication control apparatus 100.

The effective time information 1552b of each communication control apparatus 100 is stored in the storage unit 1510 of each communication control apparatus 100 while the management apparatus 350 collectively stores the effective time information 1552b of each communication control apparatus 100 in the management DB 5503 as the effective time information management table 5512b as illustrated in FIG. 12. The effective time information 1552b illustrated in FIG. 12 is an example, and can be set or changed according to the installation location of the communication control apparatus 100 and the operation method of the system. In this case, the communication control apparatus 100 or the management apparatus 350 are configured to set and change the effective time information 1552b.

As to the above described variant example of the first embodiment, the effective time information 1552b includes the activation time information such as the activation time point or period used for activating the communication control function of the communication control apparatus 100 (i.e., time point or period not to deactivate the communication control function of the communication control apparatus 100), and the deactivation time information such as the deactivation time point or period used for deactivating the communication control function of the communication control apparatus 100. With this configuration, the communication control function of the communication control apparatus 100 can be activated (cannot to be deactivated) in conjunction with the system environment such as the time schedule of a class and the reservation time of a conference room. Further, the communication control function of the communication control apparatus 100 can be deactivated during a break time or a time not reserved for use.

### Second Embodiment

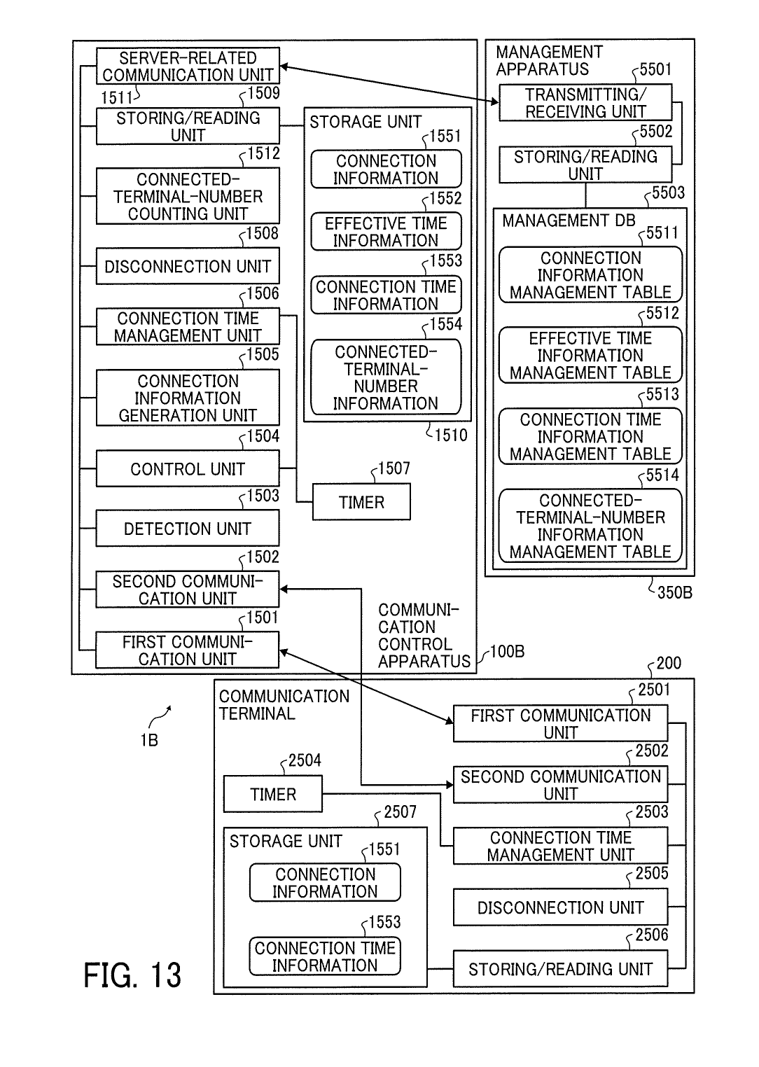

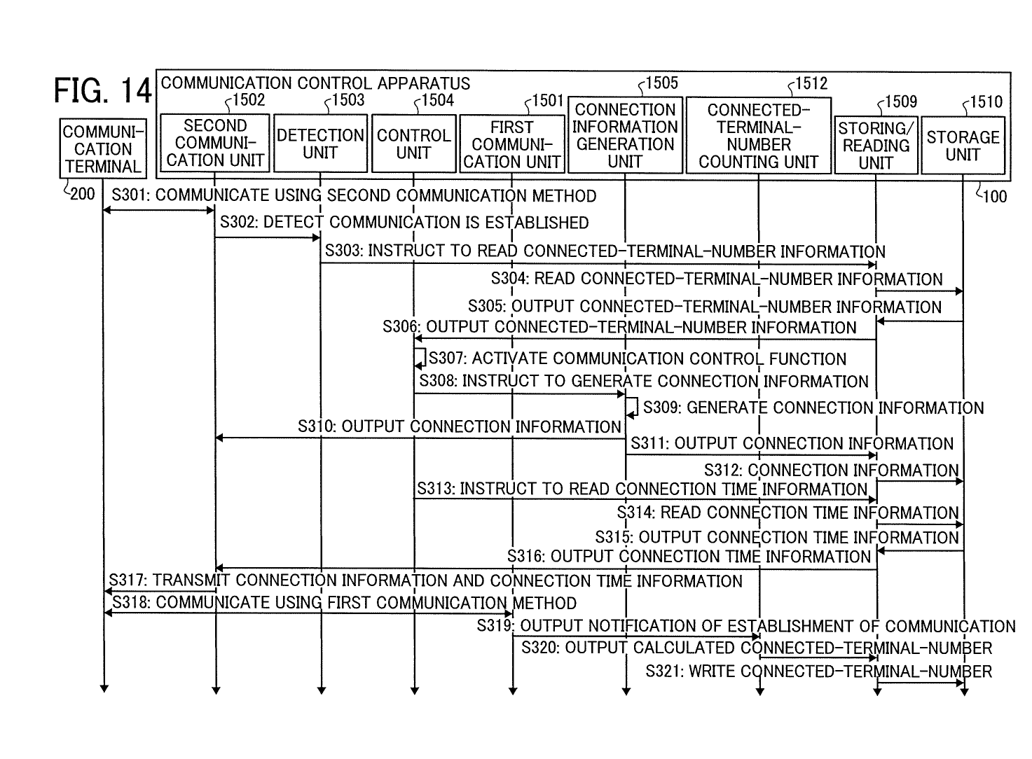

Hereinafter, a description is given of a communication control system of a second embodiment with reference to FIG. 13. The communication control system of the second embodiment includes a connected-terminal-number information 1554 including information of the number of the communication terminals 200 being connected to the communication control apparatus 100 using the first communication method, in addition to the effective time information 1552 used for deactivating the communication control function. The same configuration and same function as those of the first embodiment are denoted by the same reference numerals, and the description thereof will be omitted.

### Functional Configuration:

FIG. 13 illustrates an example of a functional block diagram of a communication control system 1B including a communication control apparatus, a communication terminal, and a management apparatus of the second embodiment. The same functions as those of the first embodiment are denoted by the same reference numerals, and descriptions thereof will be omitted. In addition to the functions of the first embodiment, a communication control apparatus 100B illustrated in FIG. 13 includes, for example, a connected-terminal-number counting unit 1512 that counts the number of the communication terminals 200 being connected with the communication control apparatus 100B. Further, connected-terminal-number information 1554 is stored in the storage unit 1510. The connected-terminal-number information 1554 includes information indicating the number of the connected communication terminal 200 counted by the connected-terminal-number counting unit 1512, and information of a threshold value indicating the number of the connected communication terminal 200 used for deactivating the communication control function of the communication control apparatus 100.

The connected-terminal-number counting unit 1512 counts the number of the communication terminal 200 being connected to the communication control apparatus 100 using the first communication method by the first communication unit 1501. The connected-terminal-number counting unit 1512 is implemented by, for example, executing programs using the CPU 1001 illustrated in FIG. 3.

The control unit 1504 deactivates the communication control function when the number of the communication terminal 200 being connected to the communication control apparatus 100 using the first communication method is equal to or less than a threshold value included in the connected-terminal-number information 1554. The threshold value indicates the number of the connected communication terminal 200 used for deactivating the communication control function. The threshold value may be set, for example, zero indicating that no communication terminal 200 is connected to the communication control apparatus 100 using the first communication method, which means the communication terminal 200 is not present in a room. However, the threshold value is not limited zero indicating that no communication terminal 200 is connected communication control apparatus 100 using the first communication method (i.e., no communication terminal 200 is present in the room). For example, if the information processing apparatus 300 is disposed in the room (i.e., specific area) permanently, the threshold value is preferably a given number combining the number of the information processing apparatuses 300 and the number of the communication terminals 200 connected to the communication control apparatus 100B using the first communication method. The threshold value can be set and changed by the communication control apparatus 100B or a management apparatus 350B as needed.

A description is given of a functional configuration of the management apparatus 350B. In addition to the functions of the first embodiment, the management apparatus 350B stores a connected-terminal-number information management table 5514 in the management DB 5503 as illustrated in FIG. 13. The connected-terminal-number information management table 5514 is managed by associating the connected-terminal-number information 1554 stored in each communication control apparatus 100 with the apparatus ID identifying each communication control apparatus 100. The connected-terminal-number information 1554 is transmitted from each communication control apparatus 100 to the management apparatus 350B via the transmitting/receiving unit 5501.

### Connection Processing:

Hereinafter, a description is given of a processing of deactivating the communication control function of the communication control apparatus 100B in the communication control system 1B of the second embodiment with reference to FIG. 14. FIG. 14 illustrates an example of a sequence diagram illustrating the connection processing of the communication control apparatus 100B and the communication terminal 200 in the communication control system 1B of the second embodiment.

The connection processing of the communication control apparatus 100B and the communication terminal 200 illustrated in FIG. 14 is described below as similar to FIG. 9, in which a user carrying the communication terminal 200a enters the room A disposed with the communication control apparatus 100a illustrated in FIG. 1. It is assumed that the communication terminal 200 does not exist in the room A at first, and the communication control function of the communication control apparatus 100a is in an idle mode (not activated) before the user carrying the communication terminal 200a enters the room A.

In step S301, the second communication unit 1502 of the communication control apparatus 100a, which is the communication control apparatus 100B, communicates with the communication terminal 200a using the second communication method. When the user carrying the communication terminal 200a enters the room A, the communication terminal 200a can communicate with the communication control apparatus 100a using the second communication method.

In step S302, the detection unit 1503 of the communication control apparatus 100a detects that the communication between the second communication unit 1502 and the communication terminal 200a using the second communication method is established.

In step S303, after the detection unit 1503 of the communication control apparatus 100a detects the communication between the communication control apparatus 100a and the communication terminal 200a using the second communication method, the detection unit 1503 instructs the storing/reading unit 1509 to read the connected-terminal-number information 1554.

In step S304, the storing/reading unit 1509 of the communication control apparatus 100a reads the connected-terminal-number information 1554 stored in the storage unit 1510.

In step S305, the storage unit 1510 of the communication control apparatus 100a outputs the stored connected-terminal-number information 1554 to the storing/reading unit 1509.

In step S306, the storing/reading unit 1509 of the communication control apparatus 100a outputs the read connected-terminal-number information 1554 to the control unit 1504.

In step S307, the control unit 1504 of the communication control apparatus 100a refers to the connected-terminal-number information 1554 output from the storing/reading unit 1509, and if there is no communication terminal 200 being connected to the communication control apparatus 100a using the first communication method, the control unit 1504 activates the communication control function.

In step S308, after the control unit 1504 of the communication control apparatus 100a activates the communication control function, the control unit 1504 outputs an instruction for generating the connection information 1551 to be used for performing the communication using the first communication method to the connection information generation unit 1505.

In step S309, the connection information generation unit 1505 of the communication control apparatus 100a generates the connection information 1551 to be used for performing the communication using the first communication method based on the instruction of generating the connection information 1551 received from the control unit 1504.

In step S310, the connection information generation unit 1505 of the communication control apparatus 100a outputs the generated connection information 1551 to the second communication unit 1502.

In step S311, the connection information generation unit 1505 of the communication control apparatus 100a outputs the generated connection information 1551 to the storing/reading unit 1509.

In step S312, the storing/reading unit 1509 of the communication control apparatus 100a stores the connection information 1551 in the storage unit 1510. It should be noted that step S310 can be performed before or after performing steps S311 and S312.

In step S313, the control unit 1504 of the communication control apparatus 100a instructs the storing/reading unit 1509 to read the connection time information 1553.

In step S314, the storing/reading unit 1509 of the communication control apparatus 100a reads the connection time information 1553 stored in the storage unit 1510.

In step S315, the storage unit 1510 of the communication control apparatus 100a outputs the stored connection time information 1553 to the storing/reading unit 1509.

In step S316, the storing/reading unit 1509 of the communication control apparatus 100a outputs the connection time information 1553 to the second communication unit 1502.

In step S317, the second communication unit 1502 of the communication control apparatus 100a transmits the connection information 1551 and the connection time information 1553 to the communication terminal 200a using the communication established using the second communication method.

In step S318, the first communication unit 1501 of the communication control apparatus 100a communicates with the communication terminal 200a using the connection information 1551 transmitted to the communication terminal 200. After the communication terminal 200a receives the connection information 1551 from the second communication unit 1502, the communication terminal 200a sets connection settings of the communication using the first communication method based on the received connection information 1551. Then, the communication terminal 200a establishes the communication with the communication control apparatus 100a using the first communication method.

In step S319, after the communication between the communication control apparatus 100a and the communication terminal 200a using the first communication method is established, the first communication unit 1501 of the communication control apparatus 100a outputs a notification indicating that the communication with the communication terminal 200a is established to the connected-terminal-number counting unit 1512.

In step S320, the connected-terminal-number counting unit 1512 of the communication control apparatus 100a adds one to the number of the connected communication terminal 200 being connected to the communication control apparatus 100a using the first communication method, and outputs a calculated number of the connected communication terminal 200 to the storing/reading unit 1509 as the calculated connected-terminal number.

In step S321, the storing/reading unit 1509 of the communication control apparatus 100a overwrites the connected-terminal-number information 1554 stored in the storage unit 1510 using the number of the connected communication terminal 200 calculated in step S320, and stores the overwritten connected-terminal-number information 1554 in the storage unit 1510.

### Disconnection and Deactivation of Communication Control Function:

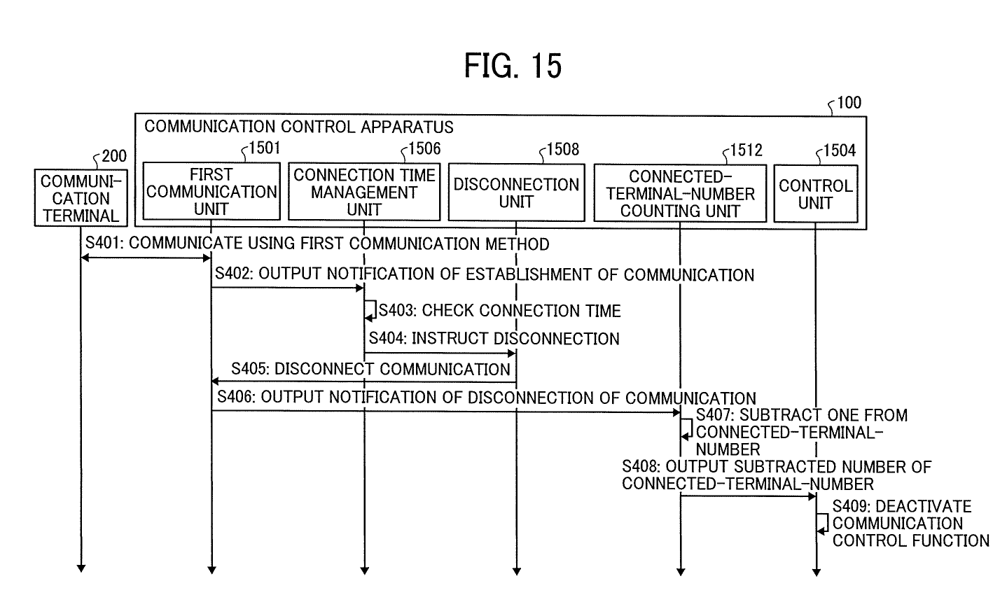

Hereinafter, a description is given of the disconnection processioning of the communication using the first communication method and the deactivation processing of the communication control function of the communication control apparatus 100B in the communication control system 1B of the second embodiment with reference to FIG. 15. FIG. 15 illustrates an example of a sequence diagram illustrating the disconnection processing of the communication using the first communication method and the deactivation processing of the control communication control function of the communication control apparatus 100B in the communication control system 1B of the second embodiment. FIG. 15 illustrates an example case that a user carrying the communication terminal 200a, who has entered the room A, uses the communication terminal 200a establishing the communication with the communication control apparatus 100a using the first communication method as illustrated in FIG. 14, and then leaves the room A.

In step S401, the first communication unit 1501 of the communication control apparatus 100a establishes the communication with the communication terminal 200a using the first communication method. The process of establishing the communication between the communication control apparatus 100a and the communication terminal 200a using the first communication method can be performed using the sequence illustrated in FIG. 14.

In step S402, after the communication between the communication control apparatus 100a and the communication terminal 200a is established using the first communication method, the first communication unit 1501 of the communication control apparatus 100a outputs a notification indicating that the communication is established to the connection time management unit 1506.

In step S403, the connection time management unit 1506 of the communication control apparatus 100a manages or checks the connection time of the communication between the first communication unit 1501 and the communication terminal 200a using the first communication method. Specifically, in response to the establishment of the communication between the communication control apparatus 100a and the communication terminal 200a using the first communication method, the connection time management unit 1506 starts to measure the connection time using the timer 1507. Further, the connection time management unit 1506 reads the connection time information 1553 stored in the storage unit 1510, and compares the connection time (e.g., threshold connection time) included in the connection time information 1553 and the connection time measured by the timer 1507.

In step S404, if the connection time measured by the timer 1507 exceeds the connection time (e.g., threshold connection time) included in the connection time information 1553, the connection time management unit 1506 of the communication control apparatus 100a outputs the disconnection instruction of the communication between the communication control apparatus 100a and the communication terminal 200a using the first communication method to the disconnection unit 1508.

In step S405, the disconnection unit 1508 of the communication control apparatus 100a disconnects the communication between the communication control apparatus 100a and the communication terminal 200a using the first communication method.

In steps S403 to S405, the communication between the communication control apparatus 100a and the communication terminal 200a using the first communication method is terminated or disconnected based on the connection time information 1553, but not limited thereto. For example, if the user carrying the communication terminal 200a leaves the room A (i.e., specific area) within a range of the connection time included in the connection time information 1553, the disconnection unit 1508 disconnects the communication between the communication control apparatus 100a and the communication terminal 200a using the first communication method without waiting of elapsing of the connection time included in the connection time information 1553.

In step S406, after the communication between the communication control apparatus 100a and the communication terminal 200a using the first communication method is disconnected by the disconnection unit 1508, the first communication unit 1501 of the communication control apparatus 100a notifies the disconnection of communication to the connected-terminal-number counting unit 1512.

In step S407, the connected-terminal-number counting unit 1512 of the communication control apparatus 100a subtracts one from the number of the communication terminal 200 being connected to the communication control apparatus 100a using the first communication method.

In step S408, the connected-terminal-number counting unit 1512 of the communication control apparatus 100a outputs information indicating the subtracted number of the connected-terminal-number of the communication terminal 200 to the control unit 1504.

In step S409, if the number of the connected communication terminal 200 is equal to or less than the threshold value indicating the number of the connected communication terminal 200 for deactivating the communication control function of the communication control apparatus 100a, the control unit 1504 of the communication control apparatus 100a deactivates the communication control function of the communication control apparatus 100a.

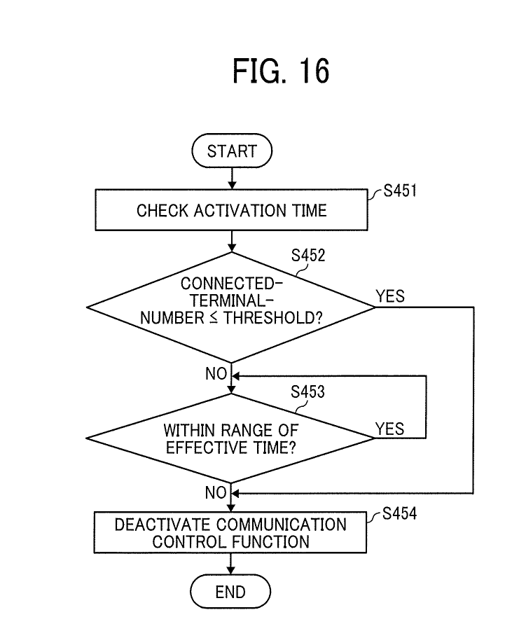

Hereinafter, a description is given of the processing of the control unit 1504 of the communication control apparatus 100a in detail with reference to FIG. 16. FIG. 16 illustrates an example of a flowchart illustrating the steps of processing of deactivating the communication control function in the communication control apparatus 100B of the second embodiment. As similar to FIG. 15, it is assumed that the communication control apparatus 100a, which is the communication control apparatus 100B, and communication terminal 200a has established the communication using the first communication method.

In step S451, the control unit 1504 of the communication control apparatus 100a activates the communication control function, and starts to manage or check the activation time. Specifically, when the control unit 1504 activates the communication control function, the control unit 1504 starts to measure the activation time using the timer 1507. Then, the control unit 1504 compares the effective time information 1552 stored in the storage unit 1510 and the activation time measured by the timer 1507.

In step S452, the communication control apparatus 100 compares the number of the communication terminal 200 being connected to the communication control apparatus 100 using the first communication method, and a threshold value indicating the number of the connected communication terminal 200 for deactivating the communication control function of the communication control apparatus 100 included in the connected-terminal-number information 1554.

If the number of the communication terminal 200 being connected to the communication control apparatus 100 using the first communication method is equal to or less than the threshold value (S452: YES), the communication control apparatus 100 proceeds the sequence to step S454. If the number of the communication terminal 200 being connected to the communication control apparatus 100 is equal to or less than the threshold value (S452: YES), in step S454, the communication control apparatus 100 deactivates the communication control function. On the other hand, if the number of the communication terminal 200 being connected to the communication control apparatus 100 using the first communication method is greater than the threshold value (S452: NO), the communication control apparatus 100 proceeds the sequence to step S453.

In step S453, the control unit 1504 of the communication control apparatus 100 compares the effective time included in the effective time information 1552 and the activation time measured by the timer 1507. If the measured activation time is still within the range of the effective time included in the effective time information 1552 (S453: YES), that is, if the measured activation time has not yet elapsed the effective time included in the effective time information 1552, the control unit 1504 of the communication control apparatus 100 repeats step S453. On the other hand, if the measured activation time exceeds the effective time included in the effective time information 1552 (S453: NO), that is, if the measured activation time has elapsed the effective time included in the effective time information 1552, the communication control apparatus 100 proceeds the sequence to step S454.

In step S453, after the communication control function is activated, the communication control apparatus 100 reads the effective time information 1552 stored in the storage unit 1510. Further, when the communication control function is activated, the communication control apparatus 100 starts to measure the activation time using the timer 1507. The measurement of the activation time using the timer 1507 is started at a time when the communication control function is activated as above described, but the measurement of activation time using the timer 1507 can be started based on a pre-set time or timing.

If the measured activation time exceeds the effective time included in the effective time information 1552, that is, if the measured activation time has elapsed the effective time included in the effective time information 1552 (S453: NO), in step S454, the communication control apparatus 100 deactivates the communication control function.

As to the above described second embodiment, the communication control apparatus 100B controls the activation or deactivation of the communication control function based on the number of the connected communication terminal 200 being connected to the communication control apparatus 100 using the first communication method, and the effective time information 1552. Therefore, the communication control function can be deactivated without referring to the effective time information 1552 when the activation of the communication control function is not required, such as when no communication terminal 200 is connected to the communication control apparatus 100 or when the number of the connected communication terminal 200 is equal to or less than the threshold value.

### Third Embodiment

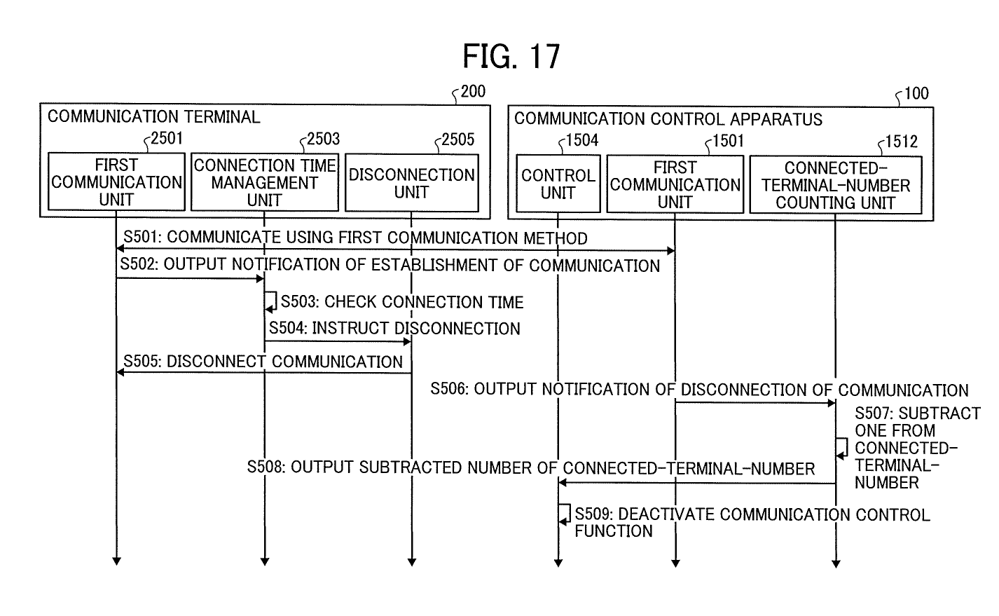

Hereinafter, a description is given of a third embodiment with reference to FIG. 17. A communication control system of the third embodiment describes a case that the communication terminal 200 performs the disconnection processing of the communication established between the communication control apparatus 100 and the communication terminal 200 using the first communication method. The same configurations and functions as those of the first and second embodiments are denoted by the same reference numerals, and the description thereof will be omitted.

### Disconnection and Deactivation of Communication Control Function:

FIG. 17 illustrates an example of a sequence diagram illustrating disconnection processing of communication using the first communication method and deactivation processing of communication control function of the communication control apparatus in the communication control system of the third embodiment. Similar to FIG. 15, FIG. 17 illustrates an example case that a user carrying the communication terminal 200a, who has entered the room A, uses the communication terminal 200a establishing the communication with the communication control apparatus 100a using the first communication method as illustrated in FIG. 14, and then leaves the room A.

In step S501, the first communication unit 2501 of the communication terminal 200a establishes the communication with the communication control apparatus 100a using the first communication method. The process of establishing the communication between the communication control apparatus 100a and the communication terminal 200a using the first communication method can be performed using the sequence illustrated in FIG. 14.

In step S502, after the communication between the communication control apparatus 100a and the communication terminal 200a is established using the first communication method, the first communication unit 2501 of the communication terminal 200a outputs a notification indicating that the communication is established to the connection time management unit 2503.

In step S503, the connection time management unit 2503 of the communication terminal 200a manages or checks the connection time with the first communication unit 1501 of the communication control apparatus 100a. Specifically, in response to a start of the connection with the communication control apparatus 100a, the connection time management unit 2503 starts to measure the connection time using the timer 2504. Further, the connection time management unit 2503 reads the connection time information 1553 transmitted from the communication control apparatus 100a and stored in the storage unit 2507, and compares the connection time included in the connection time information 1553 and the connection time measured by the timer 2504.

In step S504, if the connection time measured by the timer 2504 exceeds the connection time included in the connection time information 1553 (or if the connection time has elapsed the connection time included in the connection time information 1553), the connection time management unit 2503 of the communication control apparatus 100a outputs the disconnection instruction of the communication with the communication control apparatus 100a using the first communication method to the disconnection unit 2505.

In step S505, the disconnection unit 2505 of the communication terminal 200a disconnects the communication between the communication control apparatus 100a and the communication terminal 200a using the first communication method.

In steps S503 to S505, the communication between the communication control apparatus 100a and the communication terminal 200a using the first communication method is terminated or disconnected based on the connection time information 1553, but not limited thereto. For example, if the user carrying the communication terminal 200a leaves the room A (i.e., specific area) within a range of the connection time included in the connection time information 1553 (i.e., before the measured connection time has elapsed the connection time included in the connection time information 1553), the disconnection unit 2505 disconnects the communication between the communication control apparatus 100a and the communication terminal 200a using the first communication method without waiting of elapsing of the connection time included in the connection time information 1553.

In step S506, after the communication with the communication terminal 200a using the first communication method is disconnected by the disconnection unit 2505 of the communication terminal 200a, the first communication unit 1501 of the communication control apparatus 100a notifies the disconnection of communication to the connected-terminal-number counting unit 1512.

In step S507, the connected-terminal-number counting unit 1512 of the communication control apparatus 100a subtracts one from the number of the communication terminal 200 being connected to the communication control apparatus 100a using the first communication method.

In step S508, the connected-terminal-number counting unit 1512 of the communication control apparatus 100a outputs information of the subtracted number of the connected communication terminal 200 to the control unit 1504.

If the number of the connected communication terminal 200, output in step S508, is equal to or less than the threshold value indicating the number of the connected communication terminal 200 for deactivating the communication control function of the communication control apparatus 100, in step S509, the control unit 1504 of the communication control apparatus 100a deactivates the communication control function of the communication control apparatus 100a.

As to the above described embodiments, the communication control apparatus 100 is equipped with the communication control function that controls communication with the communication terminal 200 located in the specific area using the first communication method, and transmits the connection information 1551 used for performing the communication using the first communication method to the communication terminal 200 using the second communication method different from the first communication method. In this configuration, the communication control apparatus 100 communicates with the communication terminal 200 using the first communication method using the connection information 1551 transmitted to the communication terminal 200 from the communication control apparatus 100. Then, the communication control apparatus 100 deactivates the communication control function based on the effective time information 1552 including the time information for deactivating the communication control function of the communication control apparatus 100. With this configuration, the communication control apparatus 100 can prevent the unintended communication (e.g., unintended wireless communication) with the communication terminal 200 using the first communication method.

Further, the communication control apparatus 100 of the above described embodiments includes the time information such as the activation time point or range used for activating (not deactivating) the communication control function and the deactivation time point or range used for deactivating the communication control function as the effective time information 1552. Therefore, the communication control function of the communication control apparatus 100 can be activated in conjunction with the system environment such as the time schedule of class and the reservation time of a conference room. Further, the communication control function of the communication control apparatus 100 can be deactivated during a break time or a time not reserved for use.

Further, as to the above described embodiments, if the number of the communication terminal 200 being connected using the first communication method is equal to or less than the threshold value, the communication control apparatus 100 deactivates the communication control function, and thereby the communication control function can be deactivated when the communication control function of the communication control apparatus 100 is not required to be activated.

Further, as to the above described embodiments, the communication control system 1 includes, for example, the communication terminal 200, and the communication control apparatus 100 equipped with the communication control function that controls the communication with the communication terminal 200 located in the specific area using the first communication method. The communication control apparatus 100 transmits the connection information used for performing the communication using the first communication method to the communication terminal 200 using the second communication method different from the first communication method. Then, the communication control apparatus 100 and the communication terminal 200 use the connection information, transmitted to the communication terminal 200, to communicate with each other using the first communication method. Further, the communication control apparatus 100 deactivates the communication control function based on the effective time information 1552 including the time information for deactivating the communication control function. With this configuration, the communication control apparatus 100 can prevent the unintended communication (e.g., unintended wireless communication) with the communication terminal 200 using the first communication method.

Further, as to the above described embodiments, the method of controlling communication processing performed by the communication control apparatus 100 is devised. The method includes transmitting the connection information used for performing communication with the communication terminal 200 using the first communication method to the communication terminal 200 located in the specific area, using the second communication method different from the first communication method, establishing the communication with the communication terminal 200 using the first communication method based on the connection information, and deactivating the communication control function of the communication control apparatus 100 enabling the communication with the communication terminal 200 located in the specific area using the first communication method based on the effective time information 1552 (i.e., first condition) used for deactivating the communication control function of the communication control apparatus 100. With this configuration, the communication control apparatus 100 can prevent the unintended communication (e.g., unintended wireless communication) with the communication terminal 200 using the first communication method.

As to conventional communication systems, even when a user carrying a communication terminal (e.g., mobile terminal) leaves from one area where a communication control apparatus is disposed, the connection information used for connecting with the communication control apparatus remains in the communication terminal. For example, in a school, a communication terminal carried by a student is connected to a communication control apparatus in a room 1, and when the class time in the room 1 has ended, the communication terminal of the student leaves from the room 1 and may enter an adjacent room 2. However, the connection information used for connecting the communication terminal and the communication control apparatus disposed in the room 1 remains in the communication terminal even when the communication terminal of the student moves to the adjacent room 2. As a result, there is a risk that unintended wireless communication is being performed between the communication control apparatus disposed in the room 1 and the communication terminal although the communication terminal is not present in the room 1.

According to the above described embodiments, the unintended wireless communication between the communication control apparatus and the communication terminal can be prevented. Further, any one of the above-described operations may be performed in various other ways, for example, in an order different from the one described above.

The functions of each embodiment can be implemented by computer-executable programs written in legacy programming languages such as assembler, C, C++, C #, Java (registered trademark), and the like, and stored and distributed in computer-readable memory such as read only memory (ROM), electrically erasable and programmable read only memory (EEPROM), erasable programmable read only memory (EPROM), flash memory, flexible disk, compact disk read only memory (CD-ROM), compact disk rewriteable (CD-RW), digital versatile disk read only memory (DVD-ROM), digital versatile disk random access memory (DVD-RAM), DVD recording only/rewritable (DVD-R/RW), Blu-ray disc, SD card, mini disk (MD), magneto optical disc (MO) and the like, or distributed over a telecommunications line.

Further, a part or all of the functions of each embodiment can be implemented on a programmable device (PD) such as field programmable gate array (FPGA) or the like, or can be implemented as an application specific integrated circuit (ASIC), in which circuit configuration data (bit stream data), downloaded to the PD to implement the functions of the embodiments on the PD, can be distributed via a recording medium recording data described in hardware description language (HDL), very high speed integrated circuits hardware description language (VHDL), Verilog HDL, or the like for generating the circuit configuration data.

Although the description of the present invention has been made based on the embodiments described above, the present invention is not limited to the requirements described in the above embodiments. Numerous additional modifications and variations are possible in light of the above teachings. It is therefore to be understood that, within the scope of the appended claims, the disclosure of this patent specification may be practiced otherwise than as specifically described herein.

What is claimed is:

1. A communication control apparatus disposed in a specific area comprising:
circuitry configured to
implement controlling of communication processing for communication between the communication control apparatus and a communication terminal;
transmit, using a second communication scheme, connection information used for performing communication between the communication control apparatus and the communication terminal using a first communication scheme, to the communication terminal when the communication terminal exists in the specific area, the second communication scheme different from the first communication scheme;
establish the communication between the communication control apparatus and the communication terminal using the first communication scheme based on the connection information transmitted to the communication terminal;
compare a first condition including at least one of activation time information indicating activation of the controlling of communication processing and deactivation time information indicating deactivation of the controlling of communication processing, and a current time being measured in response to starting the controlling of communication; and
deactivate the controlling of communication processing when the current time being measured deviates from the activation time information indicating activation of the controlling of communication processing, or when the current time being measured corresponds to the deactivation time information indicating deactivation of the controlling of communication processing.

2. The communication control apparatus of claim 1,
wherein the deactivation time information includes a deactivation time period for deactivating the controlling of communication processing, and the circuitry deactivates the controlling of communication processing when the current time being measured corresponds to the deactivation time period.

3. The communication control apparatus of claim 1,
wherein the deactivation time information includes a deactivation time point used for deactivating the controlling of communication processing, and the circuitry deactivates the controlling of communication processing when the current time being measured corresponds to the deactivation time point.

4. The communication control apparatus of claim 1,
wherein the activation time information includes an activation time period not to deactivate the controlling of communication processing, and the circuitry deactivates the controlling of communication processing when the current time being measured deviates from the activation time period.

5. The communication control apparatus of claim 1,
wherein the activation time information includes an activation time point not to deactivate the controlling of communication processing, and the circuitry deactivates the controlling of communication processing when the current time being measured deviates from the activation time point.

6. The communication control apparatus of claim 1,
wherein the circuitry deactivates the controlling of communication processing when the number of the communication terminal, being connected to the communication control apparatus using the first communication scheme, is equal to or less than a threshold value.

7. The communication control apparatus of claim 6,
wherein the circuitry deactivates the controlling of communication processing when the communication terminal being connected to the communication control apparatus using the first communication scheme does not exist in the specific area.

8. The communication control apparatus of claim 1,
wherein the circuitry disconnects the communication using the first communication scheme based on a second condition including connection time information allowing the communication between the communication control apparatus and the communication terminal using the first communication scheme.

9. The communication control apparatus of claim 8,
wherein the connection time information includes a connection time period allowing the communication between the communication control apparatus and the communication terminal, and the circuitry disconnects the communication between the communication control apparatus and the communication terminal using the first communication scheme when the current time being measured deviates from the connection time period.

10. The communication control apparatus of claim 8,
wherein the connection time information includes a connection time point allowing the communication between the communication control apparatus and the communication terminal, and the circuitry disconnects the communication between the communication control apparatus and the communication terminal using the first communication scheme when the current time being measured deviates from the connection time point.

11. The communication control apparatus of claim 1,
wherein when the circuitry detects communication between the communication control apparatus and the communication terminal using the second communication scheme, the circuitry activates the controlling of communication processing and generates the connection information.

12. The communication control apparatus of claim 1, further comprising a memory to store the connection information,
wherein the circuitry deletes the connection information stored in the memory when the circuitry deactivates the controlling of communication processing.

13. The communication control apparatus of claim 11,
wherein the circuitry transmits the connection information to the communication terminal when the circuitry detects the communication between the communication control apparatus and the communication terminal using the second communication scheme in the specific area.

14. A communication control system including a communication control apparatus disposed in a specific area, the communication control system comprising:
circuitry configured to
implement controlling of communication processing for communication between the communication control apparatus and a communication terminal;
transmit, using a second communication scheme, connection information used for performing communication between the communication control apparatus and the communication terminal using a first communication scheme, from the communication control apparatus to the communication terminal when the communication terminal exists in the specific area, the second communication scheme different from the first communication scheme;
establish the communication between the communication control apparatus and the communication terminal using the first communication scheme based on the connection information transmitted to the communication terminal;
compare a first condition including at least one of activation time information indicating activation of the controlling of communication processing and deactivation time information indicating deactivation of the controlling of communication processing, and a current time being measured in response to starting the controlling of communication processing; and
deactivate the controlling of communication processing when the current time being measured deviates from the activation time information indicating activation of the controlling of communication processing, or when the current time being measured corresponds to the deactivation time information indicating deactivation of the controlling of communication processing.

15. A method of implementation of controlling of communication processing of a communication control apparatus disposed in a specific area, the method comprising:
transmitting, from the communication control apparatus to a communication terminal using a second communication scheme when the communication terminal exists in the specific area, connection information to be used for performing communication between the communication control apparatus and the communication terminal using a first communication scheme, the second communication scheme different from the first communication scheme;
establishing the communication between the communication control apparatus and the communication terminal using the first communication scheme based on the connection information transmitted to the communication terminal;
measuring a current time in response to starting the controlling of communication processing;
comparing a first condition including at least one of activation time information indicating activation of the controlling of communication processing and deactivation time information indicating deactivation of the controlling of communication processing, and the current time being measured; and
deactivating the controlling of communication processing when the current time being measured deviates from the activation time information indicating activation of the controlling of communication processing, or when the current time being measured corresponds to the deactivation time information indicating deactivation of the controlling of communication processing.
